(19) United States
(12) Patent Application Publication
(10) Pub. No.: US 2023/0288933 A1
(43) Pub. Date: Sep. 14, 2023

(54) SYSTEM AND METHOD FOR AUTONOMOUSLY DELIVERING SUPPLIES TO OPERATORS PERFORMING PROCEDURES WITHIN A FACILITY

(71) Applicant: Apprentice FS, Inc., Jersey City, NJ (US)

(72) Inventors: Frank Maggiore, Jersey City, NJ (US); Abdel Hassan, Jersey City, NJ (US); Emilee Cook, Jersey City, NJ (US); Angelo Stracquatanio, Jersey City, NJ (US)

(21) Appl. No.: 18/120,284

(22) Filed: Mar. 10, 2023

Related U.S. Application Data
(60) Provisional application No. 63/318,912, filed on Mar. 11, 2022.
(60) Provisional application No. 63/347,339, filed on May 31, 2022.
(60) Provisional application No. 63/426,471, filed on Nov. 18, 2022.

(51) Int. Cl. G05D 1/02; G06V 20/40; G06V 20/56; G06T 7/73

(52) U.S. Cl. CPC G05D 1/0212; G06V 20/46; G06V 20/56; G06T 7/73; G05D 1/0285; G05D 1/0251; G05D 1/0253; G06T 2207/10016; G06T 2207/30196; G05D 2201/0216

(57) ABSTRACT

One variation of a method for autonomously delivering supplies to operators within a facility includes, accessing an instructional block defining: a location within the facility; and a target offset distance between an autonomous cart and an operator proximal the location. The method also includes: maneuvering the autonomous cart carrying a set of materials to a position within the facility proximal the location; and accessing a video feed from an optical sensor coupled to the autonomous cart. The method further includes: extracting a set of features from the video feed; interpreting a set of objects depicted in the video feed based on the set of features; and calculating an offset distance between a first object in the video feed and the autonomous cart. The method also includes, in response to the offset distance deviating from the target offset distance, maneuvering the autonomous cart to the target offset distance.

### CROSS-REFERENCE TO RELATED APPLICATIONS

This application claims the benefit of U.S. Provisional Application No. 63/318,912, filed on 11 Mar. 2022, and 63/347,339, filed on 31 May 2022, each of which is hereby incorporated in its entirety by this reference.

This application also claims the benefit of U.S. Provisional Application No. 63/426,471, filed on 18 Nov. 2022, which is hereby incorporated in its entirety by this reference.

This application is related to U.S. Non-Provisional application Ser. No. 17/719,120, filed on 12 Apr. 2022, Ser. No. 16/425,782, filed on 29 May 2019, and Ser. No. 17/968,677, filed on 18 Oct. 2022, each of which is hereby incorporated in its entirety by this reference.

### TECHNICAL FIELD

This invention relates generally to the field of pharmacological manufacturing and more specifically to a new and useful method for autonomously deploying a utility cart to support production of materials in the field of manufacturing.

### BRIEF DESCRIPTION OF THE FIGURES

FIG. 1 is a flowchart representation of a method;

FIG. 2 is another flowchart representation of the method;

FIG. 3 is another flowchart representation of the method;

FIG. 4 is another flowchart representation of the method;

FIG. 5 is a flowchart representation of one variation of the method;

FIG. 6 is another flowchart representation of one variation of the method;

FIG. 7 is a schematic representation of one variation of the autonomous cart;

FIG. 8 is a schematic representation of one variation of the autonomous cart;

FIG. 9 is a schematic representation of one variation of the autonomous cart; and

FIGS. 10A and 10B are a schematic representation of one variation of the autonomous cart.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

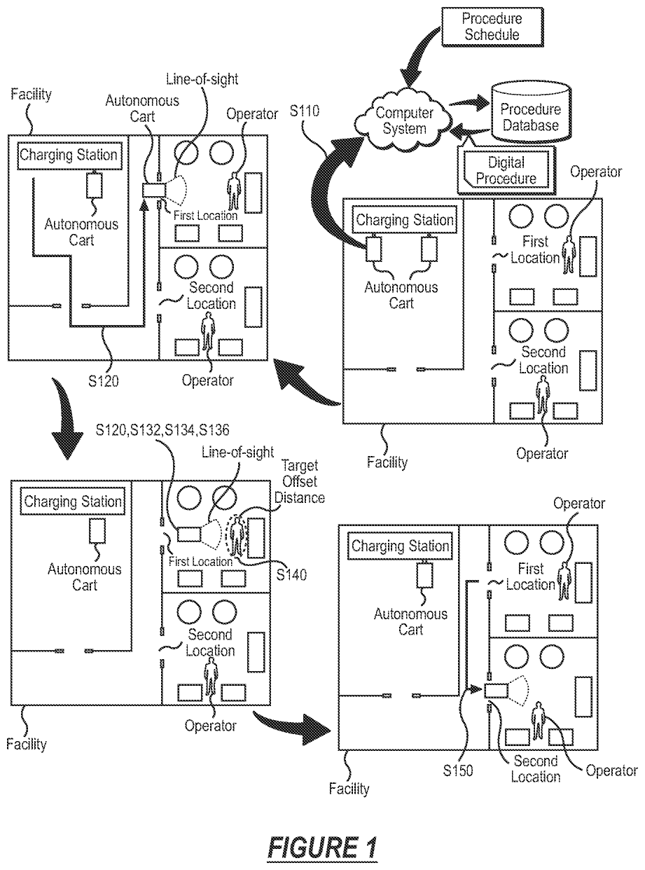

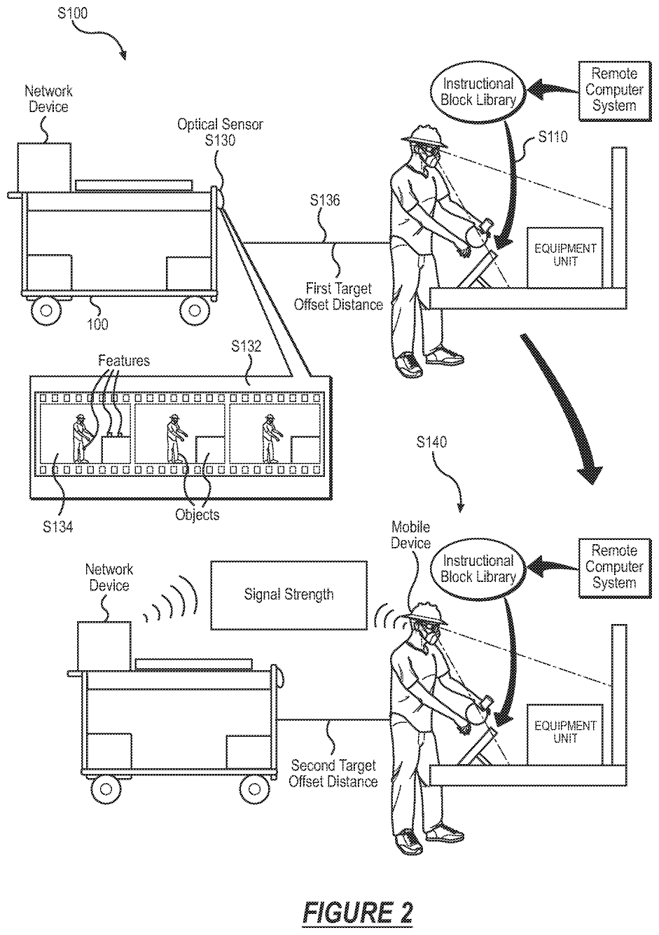

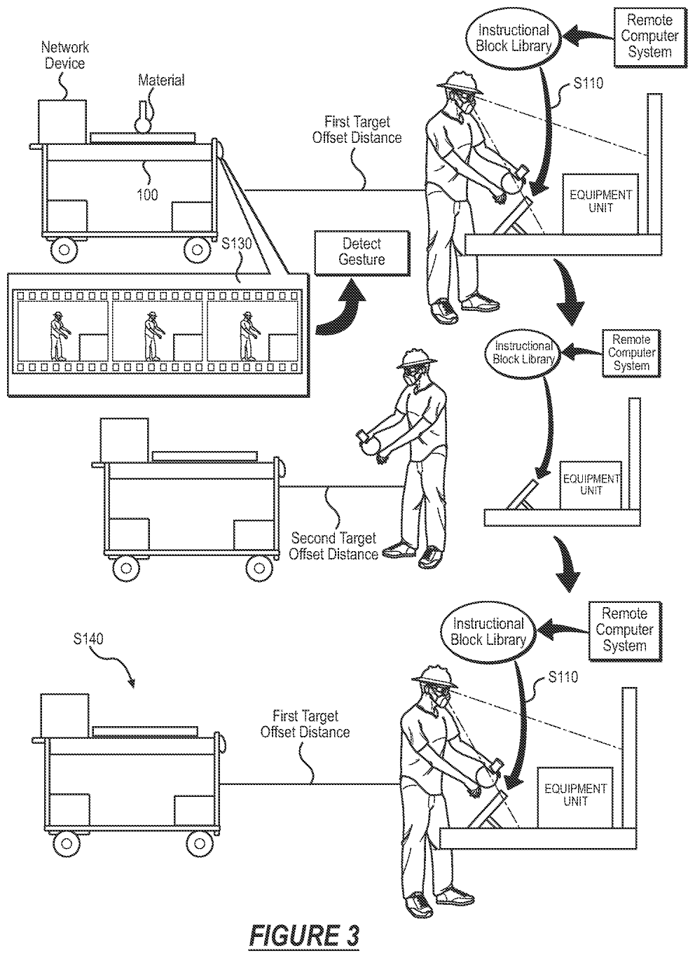

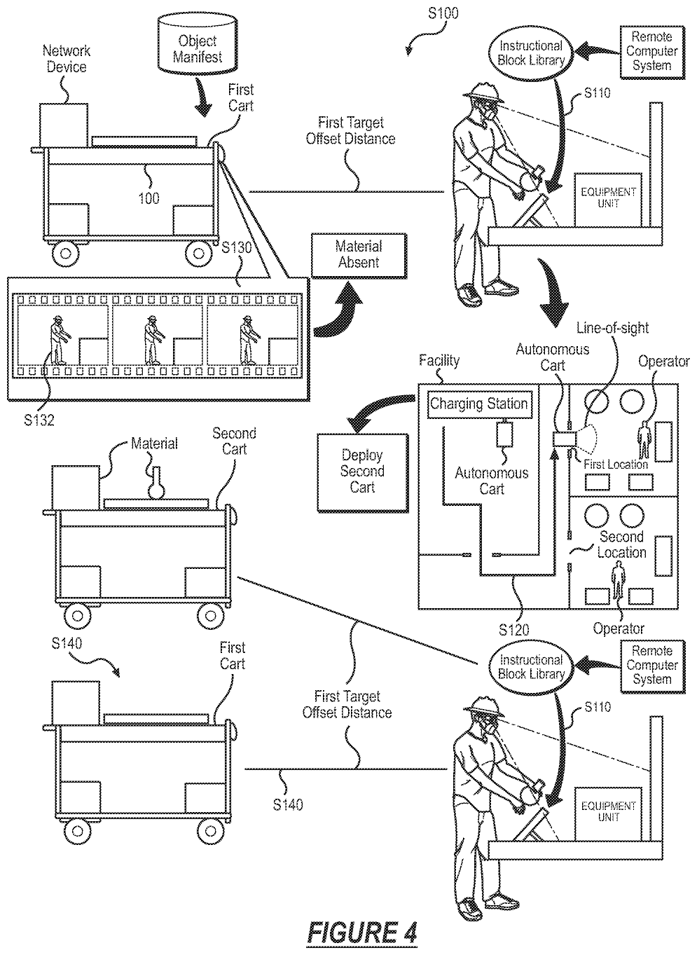

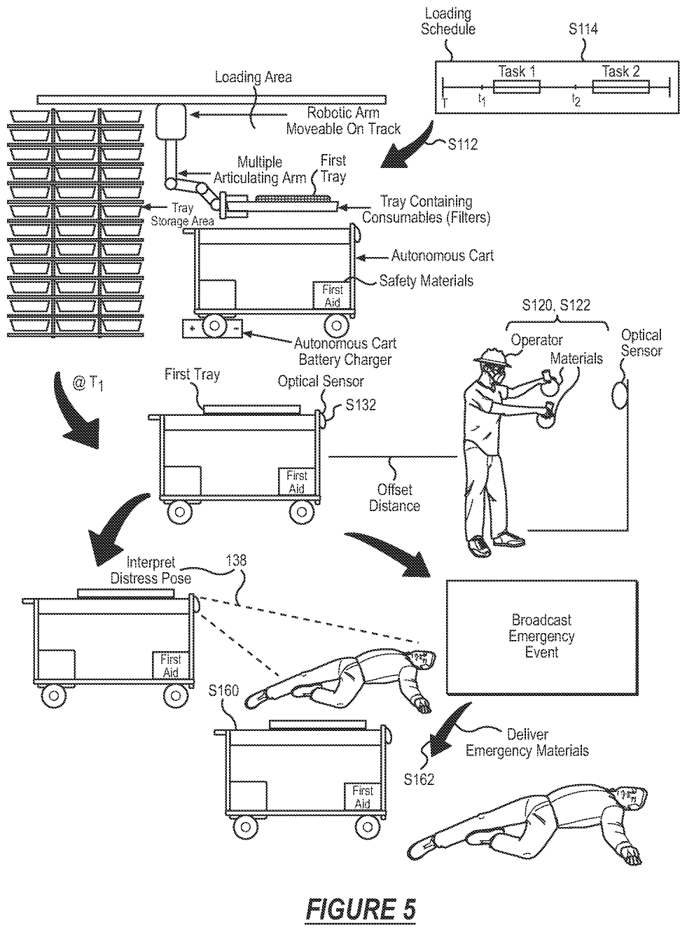

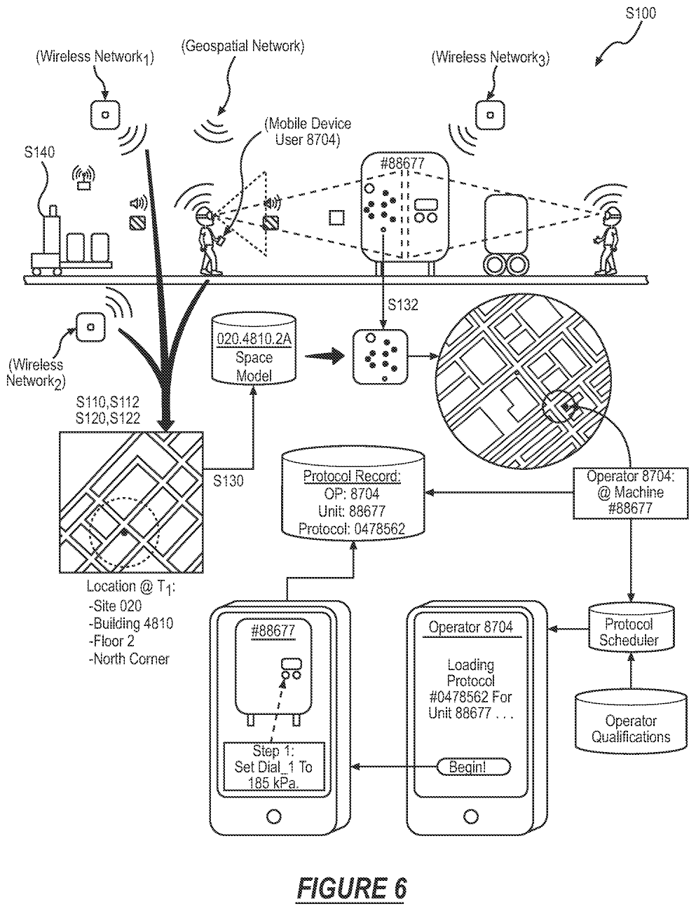

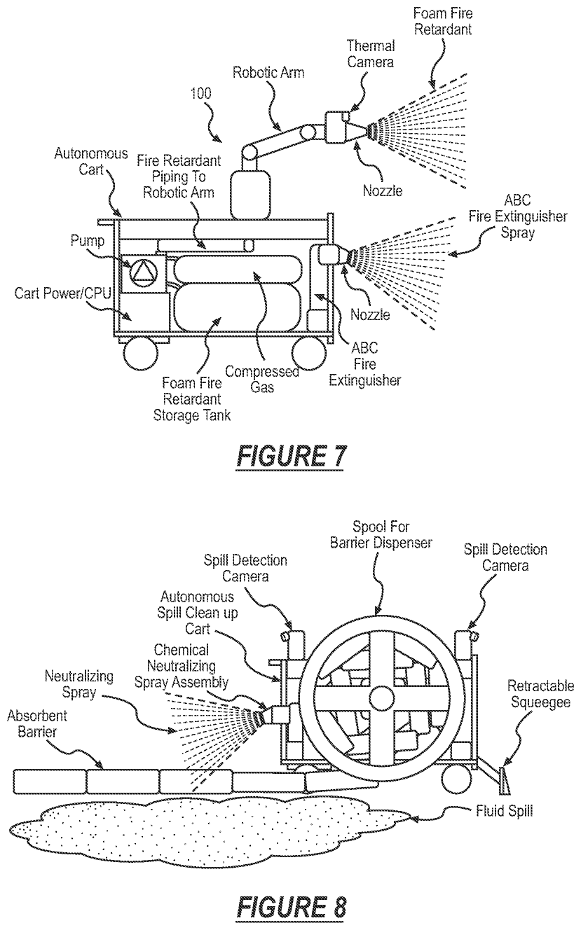

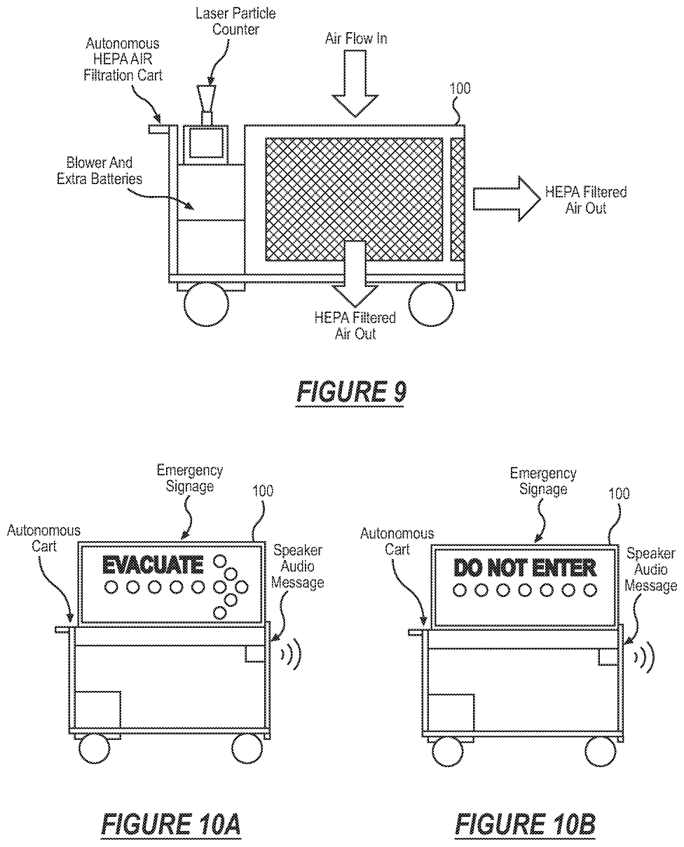

As shown in FIG. 1, a method S100 for autonomously delivering supplies to operators performing procedures within a facility includes, at a first autonomous cart, accessing a digital procedure in Block S110 containing a first instructional block, in a sequence of instructional blocks, the first instructional block including a first instruction defining: a first location within the facility; a first supply trigger associated with a first set of materials for an operator scheduled to perform the first instruction at the first location; and a first target offset distance between the first autonomous cart and the operator proximal the first location.

The method S100 also includes, at a first time prior to scheduled performance of the first instruction by the operator, maneuvering to a target position within the facility proximal the first location defined in the first instruction of the first instructional block in Block S120.

The method S100 further includes, in response to detecting the first supply trigger proximal the first location, initiating a first scan cycle in Block S130, during the first scan cycle: accessing a first live video feed from a first optical sensor coupled to the first autonomous cart and defining a first line-of-sight of the first autonomous cart in Block S132; extracting a first set of visual features from the first live video feed; interpreting a first set of objects depicted in the first live video feed based on the first set of visual features in Block S134, the first set of objects including a first object corresponding to the operator within the first line-of-sight; and calculating a first offset distance between the first object depicted in the first live video feed and the first autonomous cart in Block S136.

The method S100 also includes: in response to the first offset distance between the first object and the first autonomous cart deviating from the first target offset distance, maneuvering the first autonomous cart to the first target offset distance in Block S140; and, in response to completion of the first instruction by the operator, maneuvering the first autonomous cart to a second location within the facility associated with a second instructional block, in the sequence of instructional blocks, of the digital procedure in Block S150.

One variation of the method S100 includes: accessing a digital procedure in Block S112 containing a first instructional block, in a sequence of instructional blocks, the first instructional block including a first instruction defining: a first location within the facility; a first risk level associated with performance of the first instruction; and a first supply trigger associated with a first set of materials according to the first risk level for the first instruction.

This variation of the method S100 also includes, at a first autonomous cart containing the first set of materials: maneuvering to a target position proximal the first location within the facility in Block S120; and, in response to the operator initiating the first instruction in the digital procedure, maintaining a first target offset distance between the first autonomous cart and the operator proximal the first location in Block S122.

This variation of the method S100 further includes: accessing a first live video feed from a first optical sensor at the first autonomous cart defining a first line of sight of the operator performing the first instruction in Block S132; extracting a first set of visual features from the first live video feed; and interpreting an operator pose for the operator within the line of sight of the first autonomous cart based on the first set of visual features in Block S138.

This variation of the method S100 also includes, in response to identifying the operator pose for the operator as corresponding to a distress pose: maneuvering the first autonomous cart to a second target offset distance less than the first target offset distance between the operator and the first autonomous cart in Block S160; and deploying the first set of materials at the first autonomous cart toward the operator in Block S162.

Another variation of the method S100 includes, accessing a digital procedure in Block S110 containing a first instructional block, in a sequence of instructional blocks, the first instructional block including a first instruction specifying: a first location within the facility; a first set of materials necessary to perform the first instruction at the first location; and a first set of target objects related to performance of the first instruction.

This variation of the method S100 also includes: in response to initiating the first instructional block by an operator within the facility, identifying a first tray, in a set of trays, containing the first set of materials; and loading the first tray at a first autonomous cart within the facility in Block S114.

This variation of the method S100 further includes, at the first autonomous cart: maneuvering to a first target position within the facility proximal the first location defined in the first instruction of the first instructional block in Block S120; during a first scan cycle, accessing a first live video feed from a first optical sensor coupled to the first autonomous cart in Block S130; extracting a first set of visual features from the first live video feed; and interpreting a first object in the first live video feed related to the first instruction based on the first set of visual features and the first set of target objects in Block S134.

This variation of the method S100 also includes: maneuvering to a second target position proximal the first object depicted in the first live video feed; and in response to detecting removal of the first tray from the first autonomous cart by the operator, maneuvering the first autonomous cart to a second target position within the facility proximal a second location defined in a second instructional block, in the sequence of instructional blocks in Block S150.

### 2. Applications

Generally, an autonomous cart can execute Blocks of the method S100 to support an operator performing steps of a procedure for production of pharmacological materials within a manufacturing facility. In particular, the autonomous cart can execute Blocks of the method to: dynamically expand network access for an operator moving throughout the manufacturing facility during a procedure (e.g., around bioreactors and other large metallic equipment that may attenuate wireless signals from fixed wireless infrastructure within the manufacturing facility); autonomously deliver materials to the operator in support of the procedure; and autonomously maintain a target distance from and line of sight to the operator in order to limit obstruction to the operator, support persistent wireless connectivity for the operator, and maintain an ability to rapidly deliver materials and other support to the operator over time.

More specifically, the autonomous cart can: access a digital procedure that contains a sequence of blocks, wherein some or all of these blocks contain: a particular location within the manufacturing facility of an operator completing specified tasks; a set of materials associated with these specified tasks handled by the operator and necessary to complete these specified tasks; and a target offset distance between the autonomous cart and the operator maintainable throughout completion of the specified tasks by the operator. The autonomous cart can then navigate to this particular location within the manufacturing facility and achieve a target offset distance to the operator at the particular location, thereby delivering materials (e.g., a network device, lab equipment, guidance equipment, VR headsets) to support the operator throughout completion of specified tasks.

For example, during completion of the procedure at the particular location, the operator may adjust her position at the particular location (e.g., walking to different equipment units at this particular location) and thus: move further from or nearer to the autonomous cart; move toward or away from equipment that attenuates wireless signals from fixed wireless infrastructure in the facility; and/or move toward a designated location of a next step of the procedure associated with delivery of additional materials by the autonomous cart. Accordingly, the autonomous cart can: navigate to a particular location offset from a known start location of the procedure; retrieve a target offset distance—between the cart and the operator—assigned to the first step of the procedure; initiate a sequence of scan cycles; capture two-dimensional or three-dimensional images (e.g., color images, depth maps) of the scene around the autonomous cart via an optical sensor that defines a line-of-sight aligned with a wireless antenna orientation on the autonomous cart; detect and track a position of the operator in these images; interpret a current offset distance between the autonomous cart and the operator within line-of-sight of the autonomous cart and a radial offset between the line-of-sight of the autonomous cart and the operator; implement closed-loop controls to trigger the drive system of the autonomous cart to maneuver the cart to a target offset distance from the operator; and similarly implement closed-loop controls to trigger the drive system of the autonomous cart to align the line-of-sight of the optical sensor to the operator.

Furthermore, in this example, the autonomous cart can: access a live video feed from an optical sensor (e.g., a camera, laser range finder, LiDAR, depth sensor, or other optical sensor type) and/or an electronic sensor (e.g., Bluetooth beacons, RFIDs, or the mobile device and/or wearable devices the operator has in proximity to them)—at the autonomous cart—depicting an operator completing specified tasks at the particular location; extract a set of features (e.g., frequencies, locations, orientations, distances, qualities, and/or states) in the live video feed; detect a set of objects (e.g., humans, equipment units) in the live video feed based on the set of features; interpret an object in the set of objects as the operator performs specified tasks; and calculate a current offset distance between the autonomous cart and the operator in the live video feed. The autonomous cart can thus, in response to the current offset distance between the autonomous cart and the operator deviating from the target offset distance, trigger the drive system of the autonomous cart to modify its current position at the target location to align with the target offset position specified for the task performed by the operator.

The autonomous cart can repeat this process throughout these first step of the procedure and for each subsequent step of the procedure.

Therefore, the autonomous cart can maintain the target offset distance to the operator during completion of specified tasks, thereby supporting the operator—such as by delivering a network device to the operator and/or delivering specific materials to the operator to complete the specified tasks—as the operator moves about the facility during the procedure.

Additionally, the autonomous cart can autonomously move around obstructions within the facility—such as by moving to opposite sides of a large equipment unit—in order to achieve and maintain the target offset distance and line-of-sight to the operator. For example, the autonomous cart can: identify a subset of objects, from the set of objects identified in the live video feed from the optical sensor, obstructing line-of-sight of the operator in the live video feed; interpret offset distances between this subset of objects and the autonomous cart based on the features extracted from the live video feed; generate a pathway, based on these offset distances, the current offset distance to the operator, and the target offset distance to the operator in the live video feed to avoid the subset of objects; and trigger the drive system to maneuver the autonomous cart according to this pathway to achieve the target offset distance.

In another example, the autonomous cart can autonomously move to the set map location from the first instructional block within the facility. If the operator is outside of the set proximity threshold to the map location for the delivery of materials, then the autonomous cart will navigate to a target offset distance to the map location and/or equipment (such as a bioreactor, tank, or mobile skid). The autonomous cart can remain in a fixed position until the operator arrives to execute the first instructional block or it can reposition itself to achieve the target offset distance depending on the parameters in the first instructional block, the operator preferences, or a manual instruction from the operator to move the autonomous cart to the target offset distance to provide additional space for the operator to execute the tasks from the first instructional block.

Therefore, the autonomous cart can automatically track an operator performing specified tasks within a particular location of the manufacturing facility and automatically maneuver to the operator at a target offset distance to support the operator while simultaneously avoiding obstacles proximal the particular location.

### 2.1 Applications: Emergency Cart

Generally, a remote computer system, a robotic loading system, and an autonomous cart can cooperate to execute Blocks of the method I100 in order to support an operator performing steps of a procedure for production of pharmacological materials within a manufacturing facility. In particular, the autonomous cart can execute Blocks of the method S100 to: access a loading schedule assigned to an autonomous cart defining materials (e.g., raw materials, equipment units, consumables) needed for procedures scheduled for performance throughout the facility; identify tasks defined in the loading schedule—performed by the operator—that expose operators to a high degree of risk (e.g., fire exposure, electrical hazard exposure, fluid spills, chemical exposure, biohazardous exposure); load emergency materials (e.g., flame blankets, lockout/tagout supplies, first aid kit, defibrillators) associated with tasks defined in the loading schedule on the autonomous cart; and autonomously deliver these emergency materials to operators performing these procedures within the facility.

More specifically, the remote computer system can access a digital procedure that contains a sequence of blocks, wherein some or all of these blocks contain: a particular location within the manufacturing facility of an operator completing specified tasks; a set of materials associated with these specified tasks handled by the operator and necessary to complete these specified tasks; and a target offset distance between the autonomous cart and the operator maintainable throughout completion of the specified tasks by the operator. Additionally, the blocks can contain a particular risk level (e.g., fire risk, electrical risk, contamination risk) associated with performance of the instruction contained in the block. The remote computer system can then generate a loading schedule associated with the procedure based on the set of materials, the risk level, and an estimated time of completion for performing these specified tasks defined in the digital procedure.

Furthermore, a robotic loading system within the facility can: receive the loading schedule from the remote computer system; and autonomously load the emergency materials specified in the loading schedule onto the autonomous cart, such as by a robotic arm retrieving a tray containing these materials and loading the tray onto the autonomous cart.

The autonomous cart can then navigate to the particular location within the manufacturing facility and achieve a target offset distance to the operator at the particular location, thereby delivering emergency materials (e.g., first aid kit, defibrillators, fire extinguisher) to support the operator in response to an emergency event (e.g., operator falling on floor, materials combustion, hazardous materials exposure) during performance of the procedure.

Additionally, the autonomous cart can, during performance of tasks by the operator: maintain target offset distance from the operator performing the task; read values from sensors (e.g., optical sensors, temperature sensors) deployed at the autonomous cart; interpret an emergency event based on these values during performance of the procedure; and trigger deployment of the set of emergency materials loaded at the autonomous cart to the operator performing the procedure.

In one example, the autonomous cart can access a loading schedule defining a first task performed by an operator at a target location within the facility. In this example, the first task contains a risk level corresponding to a fire exposure risk during performance of the task in the procedure. Alternatively, the risk level of the task can be flagged during the authoring of the procedure. Thus, the autonomous cart can, prior to initiation of the first task by the operator maneuver to a loading area within the facility. The robotic loading system at the loading area can then trigger loading of a first tray including a set of emergency materials (e.g., fire blanket, plexiglass barrier) associated with the risk level onto the autonomous cart, such as by a robotic arm at the loading area and/or a local operator at the loading area. Subsequently the autonomous cart can maneuver to a particular location within the facility proximal an operator performing the first task within the facility. The autonomous cart can then: maintain a target offset distance from the operator performing the first task based on the risk level defined for the first task; and approach the operator in response to interpreting an emergency fire event during performance of the first task.

In the aforementioned example, the autonomous cart can: read temperature values from a temperature sensor at the autonomous cart; access a video feed from an optical sensor at the autonomous cart and defining a field-of-view of the operator; implement computer vision techniques to extract visual features (e.g., edges, objects) from this video feed; and interpret an operator pose of an operator depicted in the video feed. Furthermore, the autonomous cart can, in response to the temperature values exceeding a threshold temperature value and the operator pose corresponding to a distress pose (e.g., operator rolling on floor): trigger deployment of the emergency materials loaded on the autonomous cart to the operator; and broadcast a notification for an emergency event to an emergency portal associated with a first responder within the facility.

Therefore, the autonomous cart can: automatically deliver emergency materials to operators performing high risk tasks of a procedure within the facility; interpret an emergency event during performance of these tasks by the operator; and automatically trigger deployment of these emergency materials in response to interpreting an emergency event during performance of these procedures, thereby mitigating risk exposure to the operator.

### 3. Robotic Cart System

A robotic system can execute blocks of the method S100 for autonomously delivering supplies to operators performing procedures within a facility. Generally, the robotic system can define a network-enabled mobile robot that can autonomously traverse a facility, capture live video feeds of operators within the facility, and maintain a target offset distance from these operators during execution of procedures within the facility.

In one implementation, the robotic system defines an autonomous cart 100 including: a base; a drive system (e.g., a pair of two driven wheels and two swiveling castors); a platform supported on the base and configured to transport materials associated with procedures performed within the facility; a set of mapping sensors (e.g., scanning LIDAR systems); and a geospatial position sensor (e.g., a GPS sensor). In this implementation the autonomous cart further includes an optical sensor (e.g., visible light camera, infrared depth camera, thermal imaging camera) defining a line-of-sight for the autonomous cart and configured to capture a live video feed of objects within the line-of-sight of the autonomous cart. Additionally, the autonomous cart includes a network device configured to support a network connection to devices within the facility proximal the autonomous cart.

Furthermore, the autonomous cart includes a controller configured to access a digital procedure for the facility containing a first instructional block including a first instruction defining: a first location within the facility; a supply trigger associated with a set of materials for an operator at the first location; and a target offset distance between the autonomous cart and the operator proximal the first location. The controller can then trigger the drive system to navigate the autonomous cart to a position within the facility proximal the first location defined in the first instruction of the first instructional block.

Additionally, the controller can initiate a first scan cycle and, during the first scan cycle: access a live video feed from the optical sensor; extract a set of features from the live video feed; detect, based on the set of features, a set of objects in the live video feed, the set of objects including the operator at a first offset distance from the autonomous cart; and trigger the drive system to maneuver the autonomous cart to the target offset distance in response to the first offset distance of the operator deviating from the target offset distance.

The controller can further initiate a second block in the digital procedure in response to completion of the first instructional block.

### 4. Robotic Loading System

Generally, a robotic loading system includes a robotic arm mounted at a loading area within the facility and a controller configured to: receive a loading instruction, such as from the remote computer system, from the autonomous cart, and/or from an operator interfacing with an interactive display of the robotic loading system; retrieve materials from a set of materials (e.g., emergency materials) stored at the loading area and specified in the loading instruction; and autonomously load these materials onto an autonomous cart proximal the robotic arm, such as by retrieving a tray from a set of trays containing the materials.

In one implementation, the autonomous cart can: autonomously navigate to the loading area within the facility; and couple a charging station (e.g., inductive charging station, charging connector) at a particular loading location within the loading area to receive materials. In this implementation, the robotic loading system can then: receive a cart loading schedule—generated by the remote computer system—specifying a first group of materials; query a list of trays pre-loaded with materials at the loading area within the facility for the first group of materials; in response to identifying a first tray, in list of trays, containing the first group of materials, retrieve the first tray via the robotic arm; and load the first tray onto a platform of the autonomous cart.

### 5. Generating Digital Procedure

Blocks of the method S100 recite, accessing a digital procedure in Block S110 containing a first instructional block, in a sequence of instructional blocks, the first instructional block including a first instruction defining: a first location within the facility; a first supply trigger associated with a first set of materials for an operator scheduled to perform the first instruction at the first location; and a first target offset distance between the first autonomous cart and the operator proximal the first location. Blocks of the method S100 also recite, accessing a digital procedure in Block S112 containing a first instructional block, in a sequence of instructional blocks, the first instructional block including a first instruction defining: a first location within the facility; a first risk level associated with performance of the first instruction; and a first supply trigger associated with a first set of materials according to the first risk level for the first instruction.

In one implementation of the method S100, a computer system (e.g., remote computer system) can generate the digital procedure based on a document (e.g., electronic document, paper document) outlining steps for a procedure carried out in the facility and then serve the digital procedure to the autonomous cart. In this variation, the computer system can generally: access a document (e.g., electronic document, paper document) for a procedure in the facility; and identify a sequence of steps specified in the document.

In the foregoing variation, each step in the sequence of steps specified in the document can be labeled with: a particular location within the facility associated with an operator performing the step of the procedure; a target offset distance between the autonomous cart and the operator proximal the particular location of the facility; and a supply trigger defining materials—such as lab equipment, devices (e.g., VR headsets, network devices)—configured to support the operator performing the step at the particular location. Additionally, each step in the sequence of steps can be labeled with: a risk factor corresponding to a degree of risk associated with performance of the step—by the operator—at the particular location; and an event trigger corresponding to instructions executed by the autonomous cart in response to interpreting deviations from the step—performed by the operator—specified in the document and/or in response to an emergency event.

In this implementation, the remote computer system can then, for each step in the sequence of steps: extract an instruction containing the particular location, the target offset distance, the supply trigger, the risk factor, and the event trigger for the step specified in the document; initialize a block, in a set of blocks, for the step; and populate the block with the instruction for the step. Furthermore, the computer system can: compile the set of blocks into the digital procedure according to an order of the sequence of steps defined in the document; and serve the digital procedure to the autonomous cart for execution of the method S100, in the facility, to support an operator during performance of the sequence of steps specified in the document.

### 5.1 Digital Procedure: Network Support

In one implementation, a particular step in the sequence of steps specified in the document is labeled with a particular location, a target offset distance, and a particular supply trigger configured to support an operator during performance of the particular step at a location within the facility exhibiting poor network connection.

For example, the particular step can be labeled with: a particular location corresponding to a location within the facility exhibiting poor network connection by operator devices (e.g., a location within the facility proximal large bio-reactors absorbing network signals) of operators at the particular location performing the particular step; a supply trigger for delivering a network device (e.g., cellular router, wireless access point)—carried by the autonomous cart—to the operator and configured to support network connection for operator devices of the operators proximal the target location; and a target offset distance (i.e., a distance range) between the autonomous cart—carrying the network device—and the operator proximal the particular location in order to maintain a signal strength of operator devices above a threshold signal strength during performance of the step at the particular location.

The autonomous cart can therefore: access the digital procedure for the facility to support operators at locations within the facility exhibiting poor network connection; and maintain a target network connection for operator devices—carried by operators—regardless of position and orientation of the operators within the facility during performance of the step specified in the document and thereby dynamically expand network access for an operator moving throughout the manufacturing facility during a procedure.

### 5.2 Digital Procedure: Materials Support

In another implementation, a particular step in the sequence of steps specified in the document is labeled with a particular location, a target offset distance, and a particular supply trigger configured to support an operator by delivering materials (e.g., lab equipment, support equipment) pertinent to performing the particular step of the digital procedure at the particular location.

For example, the particular step can be labeled with: a particular location within the facility wherein the operator is performing the particular step of the procedure requiring a set of materials; a supply trigger corresponding to the set of materials (e.g., lab equipment, samples, VR headsets) necessary to support the operator in performing the particular step to completion at the particular location; and a target offset distance between the autonomous cart and the operator such that the set of materials—carried by the autonomous cart—is within reach (e.g., 1-2 meters) of the operator performing the particular step.

The autonomous cart can therefore: obtain contextual awareness of the steps being performed—by operators—within the facility; and autonomously maneuver the cart toward the operator to supply the set of materials necessary to perform the particular step, thereby eliminating the need for the operator to abandon the particular location to manually obtain the materials necessary for performing the steps of the procedure.

### 5.2 Digital Procedure: Risk Mitigation

In yet another implementation, a particular step in the sequence of steps specified in the document is labeled with a risk factor associated with a degree-of-risk to an operator performing the particular step. In this implementation, the particular step can be labeled with a supply trigger, target offset distance, and an event trigger to mitigate operator exposure to a hazardous event and/or materials.

For example, the particular step can be labeled with: a risk factor corresponding to a first degree-of-risk for an incendiary event associated with performance of the particular step—by the operator—at the particular location; a supply trigger corresponding to a set of materials for mitigating the incendiary event, of the first degree-of-risk, at the particular location (e.g., fire alarm, fire extinguisher); an event trigger for automatically deploying the set of materials—such as, automatically triggering a fire alarm to notify operators within the particular location of the incendiary event and/or automatically deploying a fire extinguisher to the operator—in response to breach of an incendiary event at the particular location in the facility.

In this example, in response to triggering an emergency event at the particular location, the autonomous cart can automatically maneuver away from the operator, walkways, and exits in the facility in order to provide a clear exit path for the operator and not serve as an obstruction for operators evacuating the particular location in the facility. Additionally, in response to triggering the emergency event, the system can execute Blocks of the method S100 to deploy additional autonomous carts to the particular location in order to deliver emergency supplies (e.g., first aid kits, AEDs, fire extinguishers, etc.) to aid emergency response teams in addressing the emergency at the particular location.

The autonomous cart can therefore: obtain contextual awareness of operators exposed to hazardous events and/or materials at particular locations within the facility while performing steps of the procedure; and mitigate exposure of the operator to these hazardous events and/or materials by autonomously deploying a set of materials in response to breach of these hazardous events within the facility.

### 6. Generating Loading Schedule

In one implementation, the remote computer system can access a procedure (e.g., digital procedure) scheduled for performance by an operator within the facility and including a set of instructional blocks for performing the procedure. Each block in the set of instructional blocks can include: a particular instruction for performing the procedure; an estimated duration of time for performing the particular instruction; a particular operator associated with performance of the particular instruction; a particular location within the facility associated with performance of the particular instruction; and a particular set of materials associated with performance of the particular instruction. The remote computer system can then generate the loading schedule for autonomous carts operating within the facility based on sets of materials for performing tasks in the procedure and estimated time durations for performing these tasks extracted from the procedure.

In this implementation, the remote computer system can: transmit the generated loading schedule to a computer system at the loading area within the facility; assign a set of labels—corresponding to materials necessary for performing the procedure—to a set of trays at the loading area within the facility; generate a prompt to populate the labeled set of trays with sets of materials defined in the loading schedule to assemble a set of pre-loaded trays for performing the procedure; and serve this prompt to a loading operator at the loading area within the facility.

In one example, the remote computer system can access a digital procedure including a first instructional block and a second instructional block. The first instructional block includes: a first task corresponding to combining a first material and a second material to produce a third material; a first operator performing the first task at a first location within the facility; a first estimated time duration for performing the first task; and a first set of materials including the first material and the second material of the first task. The second instructional block includes a second task corresponding to weighing the third material produced by the first task; a second estimated time duration for performing the second task; and a second set of materials including a scale (e.g., a digital scale) for weighing the third material.

Thus, the remote computer system can generate a loading schedule including: the first task spanning the first estimated time duration (e.g., 30 minutes); and the second task spanning the second estimated time duration (e.g., 10 minutes) and succeeding the first task in the loading schedule. The remote computer system can then: transmit this generated loading schedule to a computer system at a loading area within the facility; generate a first label for a first tray at the loading area corresponding to the first set of materials for performing the first task; and generate a second label for a second tray at the loading area corresponding to the second set of materials for performing the second task. A loading operator at the loading area within the facility can then assemble the first tray to include the first set of materials and the second tray to include the second set of materials.

Therefore, the remote computer system can generate the loading schedule to assemble a set of trays containing materials necessary for performing procedures at the facility prior to performance of these procedures within the facility in order to readily deliver these trays to operators performing the procedures at scheduled time windows.

### 7. Tray Loading

In one implementation, the autonomous cart can: access a loading schedule assigned to an autonomous cart defining materials (e.g., raw materials, equipment units, consumables) needed for procedures scheduled for performance throughout the facility; and trigger the drive system to autonomously maneuver the autonomous cart to a loading area within the facility. At the loading area, the robotic loading system can then: query a tray list representing a set of pre-loaded trays containing materials for performing procedures within the facility at the loading area within the facility; identify a first tray—in the tray list—containing the set of materials from the first instructional block; and trigger loading of the first tray from the set of trays at the loading area to the platform of the autonomous cart. The autonomous cart can then, prior to initiation of the first instructional block by the operator within the facility, autonomously maneuver from the loading area to a target location within the facility proximal the operator to deliver the first tray containing the set of materials.

In one example, the robotic loading system can receive a loading schedule assigned to the autonomous cart, such as by a remote computer system managing a set of autonomous carts within the facility. The loading schedule can include a set of tasks for procedures scheduled for performance in the facility over a planned time period (e.g., a day, a week) and assigned to the autonomous cart. Each task in the set of tasks can include: a particular instruction for the procedure scheduled for performance within the facility; an identifier for a particular operator assigned to performance of the particular instruction within the facility; a particular location within the facility assigned to the particular operator for performance of the particular instruction; a risk level associated with performance of the particular instruction; and a particular set of materials pertinent to performance of the particular instruction by the particular operator at the particular location within the facility.

The robotic loading system can then: identify a first set of materials associated with performance of a first task of the procedure by an operator within the facility in the loading schedule; and identify absence of the first set of materials on the autonomous cart, such as by detecting absence of objects via a weight sensor at the autonomous cart, barcode scanning, RFIDs, or detecting absence of objects via a camera at the loading area and directed to the autonomous cart, and/or identifying absence of objects in a materials log associated with the autonomous cart. The autonomous cart can then trigger the drive system to autonomously maneuver the autonomous cart to a loading area within the facility in response to identifying absence of the set of materials on the autonomous cart.

In the aforementioned example, the autonomous cart can: maneuver proximal a particular loading location within the loading area of the facility; and couple a charging station (e.g., an inductive charging plate, charging connector) configured to charge a battery of the autonomous cart during loading of materials.

At the loading station the robotic loading system can: access a tray list defining a set of trays (e.g., pre-loaded to contain a particular set of materials for performing a particular task); query the tray list to identify a first tray corresponding to a first task scheduled for performance within the facility; and, in response to identifying the first tray in the tray list, trigger loading of the first tray from the loading area to the autonomous cart, such as manually by a loading operator at the loading area and/or autonomously by the robotic arm at the loading area.

Alternatively, in response to identifying absence of the first tray in the tray list, the robotic loading system can generate: a prompt to assemble a tray containing the particular set of materials associated with performance of the first task of the procedure; and serve this prompt, such as to a loading operator portal at the loading area.

Therefore, the autonomous cart can: confirm presence of a first tray containing a first set of materials associated with performing a first scheduled task within the facility at the autonomous cart; and autonomously deploy the autonomous cart to a particular location within the facility proximal a first operator performing the first scheduled task to deliver the first tray to the operator.

In another example, the autonomous cart can maneuver to a loading area within the facility after completion of the first instructional block by the operator at the first location. Furthermore, a robotic loading system at the loading area can then: access an object manifest specifying a corpus of objects related to performance of the digital procedure; identify a second set of objects, in the object manifest, related to a second instruction in the second instructional block; and trigger loading of the second set of objects at the second autonomous cart by the robotic loading system. The autonomous cart can then, maneuver to the first target position within the facility proximal the first location in response to initiating the second instructional block in the digital procedure by the operator.

### 7.1 Baseline Emergency Materials

In one implementation, the remote computer system can: scan the digital procedure to identify a first set of materials exceeding a risk threshold (e.g., flammable materials, contagious biohazardous materials); from a manifest of emergency materials, identify a set of baseline emergency materials associated with mitigating risk exposure based on the first set of materials identified in the digital procedure; retrieve records of previously performed instances of the procedure; identify emergency events that occurred during performance of the procedure in the retrieved records; and define a trigger for deploying the autonomous cart based on the identified emergency event.

In this implementation, the robotic loading system can then: trigger loading of a first tray containing a first set of materials corresponding to a first task in the loading schedule; and trigger loading of the set of baseline emergency materials for the first task in the loading schedule. The autonomous cart can then autonomously maneuver to the operator to deliver the first tray and the set of baseline emergency materials to the operator. In this implementation, the set of baseline emergency materials can include: a first aid kit; a fire extinguisher; and/or a defibrillator.

In one example, the autonomous cart can: maneuver the autonomous cart to the loading area within the facility; detect absence of emergency materials at the autonomous cart, such as by reading values from a weight detector at the autonomous cart and/or by identifying absence of emergency materials from a material log associated with the autonomous cart; and trigger loading of these baseline emergency materials to a platform of the autonomous cart in response to detecting absence of the emergency materials at the autonomous cart.

Thus, the autonomous cart can: maneuver to deliver the first tray and these baseline emergency materials to operators within the facility; and readily deploy these baseline emergency materials in response to an emergency event during performance of procedures within the facility.

### 7.2 Specialized Emergency Materials Loading

In one implementation, the robotic loading system can access a loading schedule defining a first task performed by an operator within the facility and including: a set of materials associated with performing the first task; and a risk level associated with performing the first task.

In this implementation, the robotic loading system can: identify a set of emergency materials corresponding to the risk level from a manifest of emergency materials; trigger loading of a first tray containing the set of materials associated with performing the first task of the procedure; and trigger loading of the set of emergency materials corresponding to the risk level from the loading schedule. The autonomous cart can then autonomously maneuver to a target location within the facility proximal the operator to deliver the first tray and the set of emergency materials to the operator for performance of the first task. Thus, the autonomous cart can deliver specialized emergency materials (e.g., flame blankets, HVAC systems)—that are not included in the baseline emergency materials—to operators performing high risk tasks within the facility. In another implementation the emergency materials can be requested and prioritized by the software system for loading via the robotic loading system. This prioritization can extend to the loading of the trays with the requested emergency materials, the loading of the trays onto the nearest autonomous cart available at that time, and the prioritization of the pathway to transport the emergency materials to the required area where it was requested, including moving other autonomous carts out of the pathway and depending on the severity of the request, automatically opening roller doors along the pathway, even if the action temporarily compromises the facility airflow integrity.

### 7.3 Other Specialized Emergency Materials

Additionally and/or alternatively, the robotic loading system can trigger loading of other emergency materials corresponding to the risk level associated with performing tasks for a procedure defined in the loading schedule. For example, the emergency materials can include: containment materials for animals, viruses, bacteria, parasites and poisons; supplemental materials for failing positive pressure systems; supplemental materials for failing HVAC systems; batteries for critical utilities in the event of a power outage; and wireless network range extenders.

### 8. Autonomous Cart Navigation

Blocks If the method S100 recite, at a first time prior to scheduled performance of the first instruction by the operator, maneuvering to a target position within the facility proximal the first location defined in the first instruction of the first instructional Block in Block S120; and in response to the operator initiating the first instruction in the digital procedure, maintaining a first target offset distance between the first autonomous cart and the operator proximal the first location in Block S122.

Generally, during a navigation cycle, the cart autonomously navigates to a position and orientation—within a threshold distance and angle of a location and target orientation—specified in the instructions of a particular instructional block in preparation to capture a live video feed of an operator performing these instructions within the facility.

In one implementation, before initiating a new navigation cycle, the autonomous cart can download—from the computer system—a set of locations corresponding to locations for a set of instructions of a particular instructional block in the digital procedure and a master map of the facility defining a coordinate system of the facility. Once the autonomous cart leaves its assigned charging station at the beginning of a new navigation cycle, the autonomous cart can repeatedly sample its integrated mapping sensors (e.g., a LIDAR sensor or other indoor tracking sensors) and construct a new map of its environment based on data collected by the mapping sensors. By comparing the new map to the master map, the autonomous cart can track its location within the facility throughout the navigation cycle. Furthermore, to navigate to its target location, the autonomous cart can confirm achievement of its target location—within a threshold distance and angular offset—based on alignment between a region of the master map corresponding to the (x,y,∂) location and target orientation defined in the instructions of the instructional block and a current output of the mapping sensors, as described above. Alternatively, the autonomous cart can execute navigating to a target location defining a GPS location and compass heading and can confirm achievement of the target location based on outputs of a GPS sensor and compass sensor at the autonomous cart. Additionally, the autonomous cart can interface with a remote computer system within the facility in order to automatically open closed doors and/or operate elevators within the facility that can obstruct the path of the autonomous cart when navigating the facility.

Therefore, the autonomous cart automates delivery of materials to support operators performing steps of the procedure at particular locations within the facility and reduces the need for these operators to deviate from her particular locations to collect these materials.

In another implementation, the autonomous cart can: maneuver to a target position within the facility proximal the first location defined in the first instruction of the first instructional block; during a first scan cycle, access a live video feed from a optical sensor coupled to the autonomous cart; extract a first set of visual features from the first live video feed; interpret a first object in the first live video feed related to the first instruction based on the first set of visual features and the first set of target objects; and maneuver to a second target position proximal the first object depicted in the first live video feed. The autonomous cart can then, in response to detecting removal of the first tray from the autonomous cart by the operator, maneuver to a second target position within the facility proximal a second location defined in a second instructional block, in the sequence of instructional blocks. Therefore, the autonomous cart can arrive at the target location within the facility prior to arrival of the operator scheduled to perform the digital procedure at the target location.

In this implementation, the autonomous cart can then: access the first instructional block including the first instruction specifying a first target offset distance between the autonomous cart and the operator proximal the first location; interpret an object in the first live video feed based on the first set of visual features, the object corresponding to the operator within a line of sight of the autonomous cart; and calculate a first offset distance between the second object depicted in the first live video feed and the autonomous cart. Thus, in response to the first offset distance between the operator and the autonomous cart deviating from the target offset distance, the autonomous cart can maneuver to the target offset distance for the operator to retrieve the set of materials at the autonomous cart.

In another implementation, the autonomous cart can: receive selection from an operator at the target location to deliver a set of materials related to a current instance of the digital procedure currently performed by the operator; and maneuver throughout the facility to deliver the set of materials to the operator. In this implementation, the autonomous cart can: in response to receiving selection from the operator to deliver the set of materials, maneuver to a loading area within the facility; receive loading of the set of materials at the autonomous cart; and maneuver to a target position proximal the target location to deliver the set of materials to the operator performing the digital procedure. In this implementation, a mobile device can interface with the operator to manage a corpus of autonomous carts operating within the facility. The mobile device can present a virtual dashboard to the operator thereby enabling the operator to track the corpus of autonomous carts within the facility (e.g., via a facility map displayed at the mobile device); schedule loading of materials for sets of materials to autonomous carts indicated on the virtual dashboard; assign delivery locations to the autonomous carts within the facility; schedule delivery times for autonomous carts; and deploy (e.g., ad-hoc) a particular autonomous cart to the operator interfacing with the mobile device.

### 8.1 Detecting Supply Trigger

In one implementation, the autonomous cart can: maneuver to the target position proximal the particular location within the facility; and detect the supply trigger corresponding to a set of materials for a particular step in the digital procedure based on data retrieved from the suite of sensors at the autonomous cart. In one example, the autonomous cart maneuvers to the target position proximal the particular location within the facility. The operator can then interact with a mobile device (e.g., headset, tablet) associated with the operator in order select a particular degree of guidance (e.g., text based, video-based guidance) for the particular instruction scheduled for performance at the particular location.

The mobile device can thus, receive selection of the particular degree of guidance from the operator; and transmit the selected degree of guidance to the autonomous cart proximal the particular location. Thus, the autonomous cart can: identify a particular material—from the set of materials carried by the autonomous cart—associated with first degree of guidance, such as an equipment unit associated with the particular instruction, or a headset device associated with visual guidance; and detect the supply trigger proximal the particular location in response to identifying the particular material carried by the autonomous cart.

In another example, the autonomous cart can: access the live video feed from the optical sensor arranged at the autonomous cart; and interpret an operator pose for the operator depicted in the live video feed proximal the particular location. In this example, the autonomous cart can thus: identify the operator pose for the operator as corresponding to a gesture (e.g., wave gesture) associated with the supply trigger for the set of materials; and detect the supply trigger proximal the particular location based on identifying this gesture from the operator.

Upon the autonomous cart detecting the supply trigger proximal the particular location, the autonomous cart can then initiate a scan cycle, as described below, to maintain a target offset distance from the operator, thereby delivering the set of materials carried by the autonomous cart to the operator performing the particular instruction of the digital procedure.

Additionally or alternatively, the autonomous cart can implement additional gestures for detecting the supply trigger at the particular location, such as receiving manual selection of the supply trigger at a mobile device associated with the operator, interpreting audio gestures from the operator, and other visual gestures performed by the operator proximal the particular location.

### 8.2 Facility Map

In one implementation, the autonomous cart can: access a facility map of the facility to identify existing obstacles (e.g., bioreactors, pillars, equipment units) within particular locations of the facility; append an obstacle map—stored by the autonomous cart—with these existing obstacles; and generate baseline pathways about particular locations within the facility to avoid these existing obstacles to achieve the target offset distance to the operator performing instructions of the procedure. Therefore, the autonomous cart can modify these baseline pathways based on obstacles detected by the optical sensor—at the autonomous cart—absent from the obstacle map of the autonomous cart.

In one example, a remote computer system can: access a facility map representing a set of locations (e.g., make line locations, charging locations, loading locations) within the facility; access a procedure schedule representing procedures scheduled for performance at target locations (e.g., make lines, equipment unit locations) within the facility over a target duration of time (e.g., hour, day, week); and label a subset of locations, in the set of locations, in the facility map as corresponding to target locations for performing instances of procedures based on the procedure schedule. In this example, the autonomous cart can then: calculate a target path from an autonomous cart station, containing the autonomous cart, within the facility to the first position based on the facility map; and serve this target path to the autonomous cart within the facility. The autonomous cart can then, prior to scheduled performance of the digital procedure within the facility, maneuver to the first position according to this target path.

Therefore, the autonomous cart can: maintain contextual awareness for a corpus of procedures currently being performed within the facility prior to a planned instance of the particular digital procedure; and interpret a path for the autonomous cart that avoids congested areas within the facility, such as areas with multiple designated operators and/or areas with obstacles (e.g., equipment units).

### 9. Autonomous Cart Scan Cycle

Blocks of the method S100 recite: initiating a first scan cycle in Block S130, during the first scan cycle: accessing a first live video feed from a first optical sensor coupled to the first autonomous cart and defining a first line-of-sight of the first autonomous cart in Block S132; extracting a first set of visual features from the first live video feed; interpreting a first set of objects depicted in the first live video feed based on the first set of visual features in Block S134, the first set of objects including a first object corresponding to the operator within the first line-of-sight; and calculating a first offset distance between the first object depicted in the first live video feed and the first autonomous cart in Block S136. Blocks of the method S100 also recite, in response to the first offset distance between the first object and the first autonomous cart deviating from the first target offset distance, maneuvering the first autonomous cart to the first target offset distance in Block S140.

Generally, during the scan cycle, the autonomous cart determines an offset distance—between the autonomous cart and an operator at a particular location within the facility—and maneuvers the cart to maintain a target offset distance to the operator during performance of instructions of a particular instructional block by the operator at the particular location.

### 9.1 Operator Tracking

In one implementation, the autonomous cart can initiate the scan cycle upon confirming achievement of its target location within the facility wherein the operator is performing the first instruction of the first instructional block. Additionally or alternatively, the autonomous cart can sample a motion sensor to detect motion from an operator proximal the target location and initiate the scan cycle upon detecting motion within the line-of-sight of the autonomous cart at the target location.

During the scan cycle, the autonomous cart can: record a live video feed from the optical sensor to capture objects within a line-of-sight of the autonomous cart; and process the live video feed to extract frequencies, locations, orientations, distances, qualities, and/or states of humans and assets in the live video feed. In the foregoing implementation, the autonomous cart can implement computer vision techniques to: detect and identify discrete objects (e.g., humans, human effects, mobile assets, and/or fixed assets) in the video feed recorded by the optical sensor during the scan cycle; and interpret an offset distance—such as by triangle similarity—between these objects proximal the target location and the position of the cart within the facility. Furthermore, the autonomous cart can implement a rule or context engine to merge types, postures, and relative positions of these objects into states of rooms, humans, and other objects. The autonomous cart can thus implement object recognition, template matching, or other computer vision techniques to detect and identify objects in the live video feed and interpret offset distances between these objects and the autonomous cart.

Therefore, the autonomous cart can: interpret a current offset distance between the autonomous cart and the operator within line-of-sight of the autonomous cart and a radial offset between the line-of-sight of the autonomous cart and the operator; maintain continuous awareness of the position of an operator performing instructions at the target location within the facility; and automatically drive the cart to maintain a target offset distance between the operator and the autonomous cart, thereby supporting the operator by delivering materials—carried by the cart—to the operator.

Additionally or alternatively, in the foregoing implementation, the operator performing instructions at the target location within the facility is supported by an operator device (e.g., VR headset) configured to connect to a network device at the autonomous cart. The autonomous cart can then leverage network signals perceived by the network device—at the autonomous cart—to interpret an offset distance between the operator and the autonomous cart.

For example, during the scan cycle, the autonomous cart can: sample a received strength signal indicator (e.g., RSSI) from the network device at the autonomous cart to interpret a signal strength from the operator device; and interpret an offset distance between the operator device of the operator and the autonomous cart based on the signal strength from the network device. The autonomous cart can thus: verify the offset distance between the autonomous cart and the operator interpreted from the optical sensor with the perceived signal strength of the operator device carried by the operator; and modify the target offset distance—specified in the instructions of an instructional block—to achieve a target signal strength between the operator device and the autonomous cart. Furthermore, the autonomous cart can leverage network signals received from stationary wireless access points positioned at fixed locations throughout the facility in combination with network signals received from operator devices to then apply triangulation techniques to interpret the offset distance between the operator and the autonomous cart.

In another implementation, as described in application Ser. No. 16/425,782, filed on 29 May 2022, which is incorporated in its entirety by this reference, a remote computer system, the operator device, and the autonomous cart can cooperate to: determine a coarse location of the operator device based on geospatial data collected by the operator device; determine a location of the operator device with granulate modularity based on wireless connectivity data collected by the operator device; and determine a fine location (or “pose”) of the operator device based on optical data recorded by the operator device and a space model loaded onto the operator device.

For example, the remote computer system can: extract a first set of identifiers of a first set of wireless access points accessible by a mobile device associated with the operator at the facility; identify the first location within the facility occupied by the mobile device based on the first set of identifiers and the first instruction for the first instructional block; and access an image captured from an optical sensor arranged proximal the first location. The remote computer system can then: extract a set of visual features from the image; and calculate the first target position proximal the first location based on positions of the set of visual features relative to a constellation of reference features representing the first location.

### 9.2 Line-of-Sight

In one implementation, the autonomous cart can implement closed-loop controls to: identify obstacles in the live video feed obstructing the autonomous cart from approaching the target offset distance between the operator and the autonomous cart; and generate a pathway to maneuver the autonomous cart to avoid these obstacles and achieve the target offset distance between the operator and the autonomous cart.

In the foregoing implementation, the operator may offset her position about the particular location within the facility to perform instructions of the procedure within the facility. Therefore, in order for the autonomous cart to properly support the user, the autonomous cart can maneuver about the particular location to maintain line-of-sight of the operator at the target offset distance while simultaneously avoiding obstacles during performance of the instructions by the operator.

For example, during the scan cycle, the autonomous cart can: access a live video feed from the optical sensor on the autonomous cart; and detect a set of objects, in the live video feed, obstructing line-of-sight to the operator performing instructions of the procedure within the facility. The autonomous cart can then: interpret radial offset distances between this set of objects and the autonomous cart: calculate a pathway, based on these radial offset distances, to maneuver the autonomous cart to avoid these obstacles in order to achieve line-of-sight to the operator. The autonomous cart can then trigger the drive system to traverse the pathway and confirm achievement of line-of-sight to the operator.

In another example, the autonomous cart can: access the live video feed from the optical sensor at the autonomous cart depicting the operator proximal the particular location; and extract a set of visual features from the live video feed. In this example, the autonomous cart can then: interpret a set of objects within line of sight of the autonomous cart based on the set of features; identify a particular object, in the first set of objects, as corresponding to the operator proximal the first location; and identify a subset of objects, in the first set of objects, within the line of sight of the autonomous cart and obstructing view of the first object in the live video feed. The autonomous cart can then: calculate a target position proximal the first location based on the particular object and the subset of objects depicted in the live video feed in order to avoid the subset of objects obstructing view of the particular object; and autonomously maneuver to this target position to maintain a clear line of sight to the operator proximal the particular location.

The autonomous cart can therefore: maintain contextual awareness of obstructing objects preventing the autonomous cart from achieving the target offset distance to the operator performing instructions of the procedure; and generate pathways to maneuver the autonomous cart to avoid these obstacles while the operator traverses locations proximal the particular location to perform the instructions of the procedure.

Additionally or alternatively, the autonomous cart can: access a facility map of the facility to identify existing obstacles (e.g., bioreactors, pillars, equipment units) within particular locations of the facility; append an obstacle map—stored by the autonomous cart—with these existing obstacles; and generate baseline pathways about particular locations within the facility to avoid these existing obstacles to achieve the target offset distance to the operator performing instructions of the procedure. Therefore, the autonomous cart can modify these baseline pathways based on obstacles detected by the optical sensor—at the autonomous cart—absent from the obstacle map of the autonomous cart.

### 9.3 Target Offset Distance

In one implementation, the autonomous cart can execute consecutive scan cycles to maintain a target offset distance—specified in the digital procedure—between the autonomous cart and an operator performing steps of the procedure at a particular location within the facility.

For example, for a particular step in the procedure requiring an operator device of an operator to maintain a target signal strength (e.g., the particular step requires a supervisor to visually monitor steps performed by the operator via the operator device), the autonomous cart can: access a digital procedure of a facility containing a first instructional block including a first instruction specifying a target offset distance to support target signal strength for an operator at a particular location within the facility performing the first instruction; and navigate to the operator, at the target offset distance, to strengthen network signals for the operator device of the operator during performance of the first instruction.

The autonomous cart can therefore: interpret deviations from a target offset distance—specified in instructions within instructional blocks of a digital procedure—between the autonomous cart and the operator at the particular location; and autonomously maneuver toward the operator to maintain this target offset distance in order to support the operator throughout execution of steps of the procedure at the particular location.

### 9.4 Video Resolution

In one implementation, the autonomous cart can, during the scan cycle: detect an operator in a live video feed from the optical sensor; extract a frame from the live video feed depicting the operator; interpret a resolution for the operator depicted in the frame (i.e., a number of pixels contained in the frame depicting the operator); and modify the target offset distance—specified in the digital procedure—between the autonomous cart and the operator at a particular location within the facility in response to the resolution for the operator deviating from a target resolution.

The autonomous cart can therefore: achieve a target resolution for objects in the live video feed recorded from the optical sensor; and accurately interpret and identify these objects in the live video feed during execution of steps of the procedure within the facility.

### 9.5 Operator Profile

In one implementation, the autonomous cart can modify the target offset distance according to a particular degree-of-guidance assigned to an operator in order to support the operator—such as by decreasing the target offset distance to trigger an audio recording broadcast from a speaker at the autonomous cart for additional guidance and/or decreasing the target offset distance to prompt the operator to withdraw a VR headset from the autonomous cart to receive additional guidance—during execution of a particular step of the procedure in the facility.

For example, the autonomous cart can, during the scan cycle: detect an operator in a live video feed recorded by an optical sensor at a particular location within the facility performing the first instruction; access an operator profile for the operator—such as from a remote computer system and/or from an operator device—indicating a minimum guidance specification for the operator performing the first instruction; and modify the target offset distance between the autonomous cart and the operator performing the first instruction based on the minimum guidance specification from the operator profile.

The autonomous cart can therefore modify preset offset distances—specified in the digital procedure—according to a degree of assistance required by each operator during execution of steps of the procedure within the facility. Additionally, in the foregoing implementation, the autonomous cart can receive a prompt—such as, via an interactive display at the autonomous cart and/or via the operator device of the operator—for additional guidance for a particular step by the operator and modify the offset distance based on the prompt received for additional guidance.

### 9.6 Antenna Direction

In one implementation, the autonomous cart includes the network device including: an antenna configured to transmit network signals for supporting operator devices at a particular location within the facility; and a robotic base coupled to the antenna and configured to manipulate a direction of the antenna (e.g., within 3 degrees-of-freedom) in order to achieve a target signal strength from operator devices at the particular location within the facility.

For example, upon achieving the target offset distance, the autonomous cart can: sample the network device for network signals from an operator device of an operator, performing steps of the procedure, within a particular location of the facility; interpret a signal strength, based on these network signals, for the operator device; and trigger the robotic base to maneuver the antenna toward the operator—detected in the live video feed from the optical sensor—in response to the signal strength deviating from a target signal strength.

Therefore, the autonomous cart can automatically adjust a direction of the antenna for a network device to maintain a target signal strength for operator devices of operators preforming steps of a procedure within the facility without compromising the target offset distance specified in the instructions of the instructional blocks of the digital procedure.

In one implementation, the autonomous cart can calculate a radial offset distance, at a first positional resolution, about the autonomous cart based on the set of objects detected in the live video feed proximal the target location. The autonomous cart can then, in response to the first positional resolution of the first radial offset distance falling below a positional resolution threshold (e.g., obstructed view of the operator): read a set of wireless network signals, received from a mobile device (e.g., headset, tablet) associated with the operator, from a network device coupled to the autonomous cart; interpret a signal strength between the mobile device and the network device at the autonomous cart based on the set of wireless network signals; and calculate a second radial offset distance, at a second positional resolution greater than the first position resolution based on the signal strength and the set of objects depicted in the live video feed. Thus, the autonomous cart can, responsive to the signal strength falling below a target signal strength for the digital procedure, maneuver to maintain the second radial offset distance between the autonomous cart and the operator proximal the particular location.

Therefore, the autonomous cart can maintain a constant signal strength between the mobile device associated with the operator and a wireless communication network within the facility during performance of the digital procedure.

### 9.7 Network Support: Operator Guidance

In one implementation, the autonomous cart can: receive selection for a particular degree of guidance (e.g., audio guidance, remote viewer guidance) for the operator performing the digital procedure at the particular location within the facility; interpret a target signal strength between a mobile device associated with the operator and a network device at the autonomous cart based on the particular degree of guidance; and maintain this target signal strength throughout performance of the digital procedure by the operator.

In one example, the autonomous cart can, extract an operator profile from the digital procedure—associated with the operator assigned to perform the digital procedure at the particular location—defining: a particular degree of guidance (e.g., video guidance, remote viewer guidance) for performing the particular instruction; and a target signal strength associated with the particular degree of guidance for the particular instruction and the mobile device. In this example, the autonomous cart can then, during performance of the digital procedure at the particular location: read a first set of wireless network signals, received from the mobile device associated with the operator, from the network device coupled to the autonomous cart; interpret a signal strength between the mobile device and the network device at the autonomous cart based on the first set of wireless network signals; and, in response to the signal strength deviating from the target signal strength, calculate a particular target offset distance between the mobile device and the autonomous cart to achieve the target signal strength at the network device.

The autonomous cart can thus maneuver to this particular offset distance from the operator to maintain a constant wireless network connection between the mobile device and the network device in order to prevent disconnection of the particular degree of guidance to the operator during performance of the digital procedure.

In another example, a remote computer system can: read a first set of wireless network signals, received from a first mobile device associated with the operator, from a first set of wireless access points proximal the first location; and interpret a first signal strength between the first mobile device and the first set of wireless access points based on the first set of wireless network signals. The autonomous cart including the network device can then, in response to the first signal strength deviating from the target signal strength: maneuver to the first target position within the facility proximal the first location defined in the first instruction of the first instructional block; and maintain a target signal strength between the mobile device and the network device at the autonomous cart.

### 9.8 Operator Support: Material Delivery+Retrieval

In one implementation, the autonomous cart can: maneuver toward the operator at the target location responsive to initiating the digital procedure in order to allow the operator to retrieve a set of materials (e.g., equipment units, consumables) contained at the autonomous cart and associated with performance of the digital procedure; and, in response to completion of a particular instruction in the digital procedure, maneuver toward the operator in order to receive loading of a target material (e.g., equipment unit, samples, waste) output by the operator following completion of the particular instruction. In this implementation, the autonomous cart can: maintain a target offset distance throughout performance of the digital procedure; and maneuver toward the operator accordingly in order to deliver and/or retrieve materials as required by the digital procedure.

For example, the autonomous cart can, in response to initiating a particular instructional block by the operator: maneuver to a particular offset distance, less than the target offset distance defined in the digital procedure, between the operator proximal the particular location and the autonomous cart; generate a prompt for the operator to remove a set of materials at the autonomous cart associated with performance of the digital procedure by the operator; and serve this prompt to the operator, such as via a display mounted at the autonomous cart and/or via the mobile device associated with the operator performing the procedure. The autonomous cart can then detect removal of this set of materials (e.g., via weight sensors at the autonomous cart, barcode scanner, RFIDs, or via the optical sensor at the autonomous cart) by the operator.

The autonomous cart can then, in response to detecting removal of the set of materials from the autonomous cart, maintain a target offset distance between the operator and the autonomous cart during performance of the particular instruction. Subsequently, the autonomous cart can, following completion of the particular instructional block by the operator: maneuver to the particular offset distance, less than the target offset distance, in order to allow for the user to load a target material (e.g., deliverables from performing the digital procedure) at the autonomous cart; generate a prompt for the operator to load the target material at the autonomous cart (e.g., at a platform at the autonomous cart); and serve this prompt to the operator, such as via a display mounted at the autonomous cart and/or via the mobile device associated with the operator performing the procedure. In this example, the autonomous cart—containing the target material—can then, maneuver to a material transfer area (e.g., clean side to dirty side, dirty side to clean side) within the facility to deliver the target material for subsequent utilization within the facility.

Thus, the autonomous cart can: detect loading of this target material at the autonomous cart (e.g., via weight sensors at the autonomous cart, barcode scanner, RFIDs, or via the optical sensor at the autonomous cart) by the operator; and maneuver to a second target location (e.g., to a storage area, quality control area) within the facility associated with the target material produced from the first instructional block in the digital procedure.

### 9.9 Operator Support: Missing Materials

In one implementation, the autonomous cart can: detect absence of materials associated with performance of the digital procedure proximal the particular location within the facility; and trigger maneuvering of a second autonomous cart within the facility that contains these missing materials to the first position within the facility proximal the target location. Thus, the operator can retrieve the necessary materials for performing the particular instruction from the second autonomous cart maneuvered to the particular location.

In one example, the autonomous cart can access an object manifest (e.g., contained within the digital procedure) corresponding to a list of objects related to performance of the first instructional block in the digital procedure. The autonomous cart can then: extract a first subset of objects, from the first set of objects, related to performance of the first instruction based on the object manifest for the digital procedure; and identify absence of a second object in the object manifest absent from the first subset of objects. Furthermore, the autonomous cart can: in response to identifying absence of the second object in the first subset of objects, generate a prompt to deliver the second object to the operator proximal the first location within the facility; serve the prompt to a remote computer system; and, at the remote computer system, query an autonomous cart manifest for a second autonomous cart containing the second object.

Therefore, the remote computer system can: locate a second autonomous cart deployed at a particular location (e.g., loading area) within the facility containing a particular material necessary for the operator to complete the digital procedure; and trigger the second autonomous cart to maneuver to the target position proximal the first location to locate the second object proximal the operator at the target location.

### 10. Block Initialization

Blocks of the method S100 recite, in response to completion of the first instruction by the operator, maneuvering the first autonomous cart to a second location within the facility associated with a second instructional block, in the sequence of instructional blocks, of the digital procedure in Block S150.

Generally, upon completion of the first instructional block, the autonomous cart can: access the second instructional block contained in the digital procedure; and navigate about the facility according to instructions in the second instructional block in order to support other operators within the facility performing these instructions at various locations within the facility. Alternatively, the autonomous cart can access the second instructional block contained in the digital procedure and continue tracking the operator having completed the first instructional block to continue supporting the operator to subsequently perform instructions for the second instructional block.

In one implementation, upon completion of the first instructional block in the digital procedure, the autonomous cart can: access the digital procedure containing a second instructional block including a second instruction specifying a second target location within the facility for performing the second instruction; and navigate to the second target location in order to support an operator performing the second instruction at the second target location.

In one example of this implementation, the autonomous cart can: access a list of materials associated with performing the second instruction at the second target location; access a list of materials currently loaded at the autonomous cart; and navigate to the second target location in response to the list of materials associated with performing the second instruction being identified in the list of materials currently loaded at the autonomous cart. Additionally, in this example, the autonomous cart can: generate a prompt for a second operator at the second target location to retrieve a set of materials for performing the second instruction from the autonomous cart; serve the prompt to the second operator—such as, by an audio broadcast via speakers at the autonomous cart and/or by a virtual display at the autonomous cart—instructing the second operator to remove the set of materials; verify removal of the set of materials by the second operator (e.g., the second operator confirms removal of the set of materials at the virtual display or at a second operator device in communication with the autonomous cart); and generate a prompt for the second operator to begin the second instruction upon verification that the set of materials have been removed from the autonomous cart.

In the foregoing example, the autonomous cart can then initialize the scan cycle as described above at the second target location to: detect the second operator—at the second target location within the facility—in the live video feed from the optical sensor; interpret a second offset distance between the second operator and the autonomous cart; and maneuver the cart toward a second target offset distance—specified in the second instruction of the second instructional block—in response to the second offset distance deviating from the second target offset distance.

The autonomous cart can therefore: automatically navigate about the facility in accordance to the locations specified in the digital procedure; and maintain a specified target offset distance to support these operators performing subsequent steps of the procedure throughout the facility.

### 10.1 Deploying Second Autonomous Cart

In one implementation, a remote computer system in communication with a corpus of autonomous carts within the facility can, prior to completion of a first instructional block in the digital procedure by the operator at the target location, maneuver a second autonomous cart containing a set of materials associated with a subsequent instructional block in the digital procedure scheduled for performance by the operator at the target location. Thus, the second autonomous cart can: maintain target offset distance during completion of the first instructional block by the operator; and, in response to completion of the first instructional block by the operator, maneuver toward the operator in order to deliver the next set of materials necessary to perform the subsequent instructional block in the digital procedure.

In this implementation, the remote computer system can: extract a second instructional block—from the sequence of blocks in the digital procedure—defining a second location within the facility associated with performance of the second instruction by the operator; access an object manifest representing objects related to performance of the second instructional block by the operator; identify a second set of materials in the object manifest related to the second instructional block based on the second instruction; and query an autonomous cart list to identify a second autonomous cart containing the second set of materials. The remote computer system can then: generate a prompt for the second autonomous cart to maneuver to the target position proximal the particular location within the facility; and transmit this prompt to the second autonomous cart within the facility prior to completion of the first instructional block by the operator at the particular location. The second autonomous cart can then: maneuver to the target position within the facility proximal the particular location; and maintain a particular target offset distance, greater than the target offset distance, from the operator during performance of the first instructional block.

Therefore, the second autonomous cart can, in response to completion of the first instructional block by the operator at the particular location, maneuver toward the operator in order to deliver the next set of materials for performing a subsequent instructional block, in the set of instructional blocks, without requiring the operator to move from the particular location within the facility.

In one example, in response to completion of the first instructional block by the operator at the first location, the remote computer system can: access a second instructional block containing the second instruction specifying the second location within the facility associated with performance of the second instruction by the operator; access an object manifest representing objects related to performance of the second instructional block by the operator; and identify a second set of materials in the object manifest related to the second instructional block based on the second instruction. The remote computer system can then, query an autonomous cart list to identify a second autonomous cart containing the second set of materials. Furthermore, the second autonomous cart can then: at a second time prior to completion of the first instructional block by the operator, maneuver to a second position within the facility proximal the second location; and maintain a second target offset distance from the operator during performance of the first instructional block.

In another example, a remote computer system can, access the first instructional block including the first instruction specifying a first risk level associated with performance of the first instruction. The remote computer system can then, in response to initiating the first instructional block by an operator within the facility, identify a second tray, in a set of trays, containing a second set of materials corresponding to emergency materials associated with the first risk level; and load the second tray at a second autonomous cart within the facility. In this example, the second autonomous cart can then: maneuver to the target position within the facility proximal the first location defined in the first instruction of the first instructional block; access a live video feed from an optical sensor coupled to the second autonomous cart and defining a second line of sight of the second autonomous cart; extract a set of visual features form the live video feed; and interpret a set of objects depicted in the live video feed based on the set of visual features. The second autonomous cart can then: identify an object, in the set of objects, as corresponding to the operator within the second line of sight of the second autonomous cart; and calculate an offset distance between the object and the second autonomous cart based on the set of objects and the target position of the autonomous cart within the facility. Thus, in response to the offset distance deviating from a target offset distance associated with the first risk level, the second autonomous cart can: maneuver toward the target offset distance; and maintain the object within line of sight of the second autonomous cart during performance of the first instruction.

### 11. Variation: Dead Zones Support

In one implementation, upon completion of the digital procedure, the autonomous cart can navigate to dead zone locations (i.e., locations within the facility with poor network signal strength) and idle the autonomous cart at these dead zone locations to support network signal strength of operator devices proximal these dead zone locations. In this implementation the autonomous cart can: access a facility map, such as a facility map stored within internal memory of the autonomous cart, indicating locations of operators—within the facility—performing steps of procedures; access a network connectivity map of the facility; identify a dead zone location in the facility map based on clusters of operators and procedures within the facility map and the network connectivity map; and navigate to the dead zone location in order to support a network connection—via the network device at the autonomous cart—to operator devices proximal the dead zone location.

Therefore, the autonomous cart can automatically trigger the drive system to navigate the autonomous cart to dead zone locations within the facility to support operator devices with signal strengths below a threshold signal strength while the autonomous cart is not in use to carry out steps of the digital procedure.

### 12. Emergency Event

Blocks of the method S100 recite: extracting a first set of visual features from the first live video feed; and interpreting an operator pose for the operator within the line of sight of the first autonomous cart based on the first set of visual features in Block S138. Blocks of the method S100 also recite: in response to identifying the operator pose for the operator as corresponding to a distress pose: maneuvering the first autonomous cart to a second target offset distance less than the first target offset distance between the operator and the first autonomous cart in Block S160; deploying the first set of materials at the first autonomous cart toward the operator in Block S162.

In one implementation, the autonomous cart can: in response to initialization of a first task in a procedure by an operator, maneuver to a location within the facility proximal the operator scheduled to perform the first task; maintain a target distance from the operator during performance of the first task; interpret an emergency event during performance of the first task based on features extracted from a video feed captured by an optical sensor within field-of-view of the operator; and deploy the set of emergency materials loaded on the autonomous cart in response to interpreting the emergency event during performance of the first task.

In this implementation, the autonomous cart can: access a video feed depicting performance of the procedure by the operator; extract a first set of features from the video feed; and generate a task profile representing performance of the first task based on the first set of features. The autonomous cart can: identify multiple (e.g., “n” or “many”) features representative of performance of the digital procedure in a video feed; characterize these features over a duration of the video feed, such as over a duration corresponding to performance of a video feed in the digital procedure; and aggregate these features into a multi-dimensional feature profile uniquely representing performance of this digital procedure, such as duration of time periods, relative orientations, geometries, relative velocities, lengths, angles, etc. of these features.

In this implementation, the autonomous cart can implement a feature classifier that defines types of features (e.g., corners, edges, areas, gradients, orientations, strength of a blob, etc.), relative positions and orientations of multiple features, and/or prioritization for detecting and extracting these features from the video feed. In this implementation, the autonomous cart can implement: low-level computer vision techniques (e.g., edge detection, ridge detection); curvature-based computer vision techniques (e.g., changing intensity, autocorrelation); and/or shape-based computer vision techniques (e.g., thresholding, blob extraction, template matching) according to the feature classifier in order to detect features representing performance of the digital procedure in the video feed. The autonomous cart can then generate a multi-dimensional (e.g., n-dimensional) feature profile representing multiple features extracted from the video feed.

In one example, the autonomous cart can: in response to initialization of a first task by an operator, generate a prompt to the operator to record performance of the first task in the procedure; access a video feed captured by an optical sensor, such as coupled to the autonomous cart and/or coupled to a headset of a user depicting the operator performing the first task; and extract a set of features from the video feed. The autonomous cart can then: identify a set of objects in the video feed based on the set of features, such as hands of an operator, equipment units handled by the operator, a string of values on a display of an equipment unit; and generate a task profile for the first task including the set of objects identified in the video feed.

Therefore, the autonomous cart can: identify objects in video feeds associated with performance of tasks in the digital procedure; represent these objects in a task profile; and interpret emergency events during performance of these tasks based on deviations of the task profile exceeding a threshold deviation from a target task profile defined in the digital procedure.

### 12.1 Assigning Emergency Trigger

In one implementation, a remote computer system can assign an emergency trigger to a set of emergency materials contained at the autonomous cart based on a corresponding risk level for a currently performed instance of the digital procedure by the operator. In this implementation, the remote computer system can: access a first instructional block—from the digital procedure—including a first instruction defining a first risk level (e.g., bio-hazard risk, flame exposure risk) associated with performance of the first instruction; access an object manifest representing objects related to performance of the digital procedure; and identify a set of emergency materials in the object manifest based on the risk level associated with performance of the first instruction.

The remote computer system can then: assign a delivery location to the set of emergency materials based on the first location for the digital procedure within the facility; assign the supply trigger for the set of emergency materials according to a first set of distress poses (e.g., rolling on floor, jumping up and down) associated with the first risk level of the first instruction; and generate a loading prompt for a second autonomous cart including the set of emergency materials, the delivery location, and the supply trigger. The remote computer system can then serve the loading prompt to a robotic loading system arranged at a first loading area within the facility containing the second autonomous cart.

Thus, the second autonomous cart can: prior to scheduled performance of the first instructional block by the operator at the first location, maneuver to the first loading area within the facility to receive loading of the first set of emergency materials at the autonomous cart; in response to initiating the first instruction by the operator at the first location, maneuver to the first location proximal the operator performing the first instruction; and maintain the target offset distance between the second autonomous cart and the operator proximal the first location during performance of the first instruction.

Therefore, the autonomous cart containing materials necessary for performance of a particular instructional block in the digital procedure and the second autonomous cart containing materials for mitigating exposure to risk of an emergency event during performance of the particular instructional block can each maintain a target offset distance from the operator during performance of the digital procedure.

### 12.2 Operator Pose

In one implementation, the autonomous cart can: extract a set of features from a video feed depicting the operator performing the first task; interpret an operator pose for the operator performing the first task based on the set of features extracted from the video feed; and identify an emergency event during performance of the first task by the operator in response to the operator pose corresponding to a distress operator pose. In this implementation, a pose of the operator during performance of the first task can vary depending on an emergency situation that can arise during performance of tasks in a procedure. In particular, during an emergency event, the autonomous cart can interpret a distress pose for the operator corresponding to the operator rolling on the floor, running around, and/or jumping up and down. Alternatively, the autonomous cart can interpret an operator pose representing the operator in an idle position indicating that no emergency event is occurring.

In one example of this implementation, the autonomous cart can, during performance of the first task of the procedure: access a video feed depicting the first operator from an optical sensor coupled to the autonomous cart; extract a set of features from the video feed; identify an operator pose for the operator based on the set of features extracted from the video feed corresponding to the operator lying on the floor; and interpret an emergency event in response to interpreting the operator pose as a distress operator pose. Additionally, the autonomous cart can: trigger deployment of the set of emergency materials loaded on the autonomous cart; generate a notification containing an emergency event alarm and the identified operator pose for the operator; and serve this notification to a supervisor within the facility and/or serve this notification to first responders within the facility.

In this example, the autonomous cart can trigger deployment of the set of emergency materials, such as by: reducing the target offset distance between the operator and the autonomous cart; automatically deploying a fire extinguisher toward the operator; automatically ejecting a flame blanket toward the operator; and/or broadcasting instructions to the operator to remove emergency materials from the autonomous cart and instructing the operator to manually deploy the materials retrieved from the autonomous cart.

In another implementation, the autonomous cart can: interpret an emergency event during performance of a first task by an operator based on the identified pose of the operator; detect absence of emergency materials at the autonomous cart, such as based on a weight sensor at the autonomous cart and/or a materials manifest associated for the autonomous cart. In this implementation, the remote computer system can then: query a list of autonomous carts operating within the facility; identify a second autonomous cart containing the set of emergency materials; generate a prompt to maneuver the second autonomous cart to a target local operator proximal the operator to deliver the set of emergency materials; and serve this prompt to the second autonomous cart. The second autonomous cart can then autonomously maneuver to the operator to deliver the set of emergency materials.

In one implementation, the autonomous cart can: access a live video feed from an optical sensor at the autonomous cart defining a line of sight of the operator performing the particular instruction; extract a set of visual features from the live video feed; and interpret the operator pose for the operator within the line of sight of the second autonomous cart based on the set of visual features. The autonomous cart can then, in response to identifying the operator pose for the operator as corresponding to a distress pose (e.g., jumping up and down, rolling on floor): maneuver the autonomous cart to a particular target offset distance less than the target offset distance between the operator and the autonomous cart; and deploy the set of emergency materials at the autonomous cart toward the operator. Additionally, the autonomous cart can then, as described in U.S. Non-Provisional application Ser. No. 17/968,677, stream the live video feed to a remote viewer to observe the operator. The autonomous cart can: receive control inputs from the remote viewer in order to manually maneuver the autonomous cart; and broadcast (e.g., visually, audibly) instructions received from the remote viewer in order to assist the operator in mitigating the emergency event.

Therefore, the autonomous cart can detect emergency events during performance of procedures in the facility based on identified poses of operators performing these procedures in order to automatically deploy emergency materials, thereby mitigating risk exposure for the operator.

### 12.2.1 Second Optical Sensor

In one implementation, the autonomous cart can: access a first video feed from a first optical sensor at the autonomous cart and defining a first field-of-view for the operator; and access a second video feed from a second optical sensor at a make line within the facility and defining a second field-of-view for the operator.

In this implementation, the first video feed accessed by the autonomous cart can define only a partial view of the operator performing the first task of the procedure. As such, the autonomous cart can access multiple video feeds depicting the operator performing the first task from different angles and/or orientations within the facility. Subsequently, the autonomous cart can: extract a first set of features from the first video feed; and identify a first operator pose of the first operator based on the first set of features.

Additionally, the autonomous cart can: extract a second set of features from the second video feed; and identify a second operator pose of the first operator based on these second set of features. The autonomous cart can then: calculate a global operator pose based on the first operator pose and the second operator pose, thereby achieving greater accuracy of pose identity for the operator performing the first task.

In one example, the autonomous cart can: interpret an operator pose, at a first pose resolution, for the operator within the line of sight of the autonomous cart based on the first set of features extracted from a live video feed; and identify the first pose resolution as falling below a threshold pose resolution, such as resulting from a set of objects obscuring the operator within line of sight of the autonomous cart. The autonomous cart can then, in response to the first pose resolution falling below a threshold pose resolution: access a second live video feed from a second optical sensor (e.g., fixed camera at make-line) arranged proximal the first location within the facility and defining a second line of sight, different from the first line of sight, of the operator performing the particular instruction; and extract a second set of visual features from the second live video feed. Furthermore, the autonomous cart can: access a third live video feed from a third optical sensor arranged at a headset device (e.g., VR headset) associated with the operator and defining a third line of sight, different from the first line of sight and the second line of sight, of the operator performing the particular instruction; and extract a third set of visual features from the third live video feed. Thus, the autonomous cart can leverage visual features extracted from video feeds depicting different line of sight to the operator in order to interpret an operator pose, at a second resolution greater than the first resolution, for the operator during performance of the digital procedure.

Therefore, the autonomous cart can interpret an emergency event based on the global operator pose derived from the first optical sensor and the second optical sensor, thereby increasing accuracy of emergency events that can occur during performance of tasks in the procedure.

### 12.2.2 Autonomous Cart Sensors

In one implementation, the autonomous cart can include a suite of sensors, such as temperature sensors, optical sensors, gas sensors, humidity sensors, pressure sensors, vibration sensors, and radiation sensors. In this implementation, the autonomous cart can: read values from this suite of sensors; and, in response to a value exceeding a threshold value, interpret an emergency event during performance of the first task. For example, the autonomous cart can: read a first temperature value from a temperature sensor at the autonomous cart; and interpret an emergency event in response to the first temperature value exceeding a threshold temperature value to indicate an active fire proximal the operator performing the first task.

Thus, the autonomous cart can: leverage data retrieved from optical sensors arranged proximal the operator and the suite of sensors at the autonomous cart to interpret emergency events during performance of digital procedures by the operator; and trigger the autonomous cart to deploy a set of emergency materials toward the operator according to the interpreted emergency event to support the user.

### 12.3 Example: Explosion Emergency

In one example, the robotic loading system can access a loading schedule defining a first task performed by the operator within the facility that includes a risk level corresponding to an explosion exposure risk associated with performance of the first task.

In this example, the robotic loading system can: identify a set of explosion emergency materials (e.g., air monitors, flame blankets, plexiglass barrier, thermal camera) corresponding to the explosion exposure risk level from a manifest of emergency materials; and trigger loading of the set of explosion emergency materials. The autonomous cart and the equipment it contains can be rated for operation in a potentially explosive environment, which can include the barrier protection for prevention of any potential as an ignition source (sparks). This can include using an autonomous cart and associated equipment with certifications for operation in potentially explosive environments including but not limited to ATEX (Zone 1 or 2), IECEx (Class 1, Division 1 or 2), EAC, INMETRO, KOSHA, CSA, UL, IP66, and other related certifications. The autonomous cart can then autonomously maneuver to a target location within the facility proximal the operator to deliver the set of explosion emergency materials to the operator for performance of the first task. Thus, the autonomous cart can automatically deploy the set of explosion emergency materials—that are not included in the baseline emergency materials—to operators performing explosion exposure tasks within the facility.

### 12.4 Example: Fire Prevention

In another example, a specialized firefighting autonomous cart can be pre-deployed for the execution of a task in a procedure which is flagged as a fire risk or is dispatched during an emergency. This specialized firefighting autonomous cart can contain an onboard fire suppression system to contain a fire at its source or to provide sufficient protection to allow the human operators to escape the area before the fire spreads further. The specialized firefighting autonomous cart can be dispatched into environments or conditions that are too dangerous for human operators to go and can be sacrificed if needed to aid in the evacuation of people in dangerous situations.

This specialized firefighting autonomous cart can be ruggedized for operating in high temperature environments, including a stronger frame, more robust wheels, with heat shielded electronics, motors, and power. In one implementation, a specialized firefighting autonomous cart contains an onboard fire suppression system of fire retardant (such as a foam fire retardant, water or other fluid, compressed CO2, powder or other chemicals), compressed gas (like nitrogen) to pressurize and dispense the fire retardant as a frothy foam for optimal coverage, a pump to move the materials to a dispensing arm, a robotic dispensing arm to position the nozzle to the optimal position for dispersing or putting out a fire, a sensor array containing cameras, such as a thermal camera for location of the fire source, and a dispensing nozzle to direct and dispense the foam fire retardant or fluid onto the fire source.

The sensor array can contain at least one thermal camera, preferably an infrared thermal camera, that is required for operations utilizing flammable materials that do not give off any flame, smoke, or indication of burning to cameras operating in the visual range of the spectrum. These materials include solvents like ethanol, methanol, and other alcohols, ketones like acetone, ethers, amides, amines, and other solvents that burn cleanly and are nearly invisible to the human eye or cameras without the use of thermal cameras or infrared detection. Some of these flammable materials require specialized fire retardants to extinguish them such as alcohol-resistant, aqueous film-forming foam (AR-AFFF) which will need to be on standby when these flammable materials are used in processes.

The robotic arm and spraying activities on the specialized firefighting autonomous cart can be controlled remotely by a trained operator or service provider that can manually navigate the autonomous cart, control the positioning of the robotic arm, provide the command to initiate the spraying, and to control the spray pattern and movement of the arm for protecting the operators in the area and putting out the fire source. These remotely operated commands can utilize existing WiFi and other network access methods and/or utilize more robust radio signaling tools as during a fire, power and network access can be interrupted due to physical damage in the facility or as a pre-emption to prevent the further spread or damage.

In alternate embodiments an AI system can autonomously control the dispatch of the specialized firefighting autonomous carts. This AI system can know the location of all of the operators in a facility based on the mobile devices they carry, the locations of the steps they are currently executing in the system, and from live video feeds within a facility where computer vision can be utilized to recognize where the operators are located. This AI system can send one or more specialized firefighting autonomous carts in a swarm to assist in the evacuation of the operators from the facility, to provide a safe pathway for the operators to escape, and to extinguish the source of the fire, if possible.

The specialized firefighting autonomous cart can include additional fire extinguishers which can be automatically dispensed if the fire gets too close to the autonomous cart or in the protection of other people in the area to allow them the opportunity to escape from the area.

In another example, the autonomous cart can: interpret a fire emergency event during performance of the digital procedure by the operator based on an operator pose interpreted for the operator and additional data retrieved from a suite of sensors (e.g., temperature sensors, humidity sensors) arranged proximal the particular location (e.g., coupled to the autonomous cart). In this example, the autonomous cart can: read a timeseries of temperature values from a temperature sensor arranged proximal the operator at the first location; and identify a subset of temperature values, in the timeseries of temperature values, exceeding a threshold temperature value corresponding to the first risk level for the first instruction. The autonomous cart can then: extract a first set of distress poses associated with the first risk level—corresponding to a flammable risk level—for the first instruction; and identify the operator pose as corresponding to a first operator pose, in the set of distress poses, associated with the operator rolling on the floor proximal the first location. Furthermore, the autonomous cart can then: identify an emergency fire event at the first location within the facility based on the first subset of temperature values and the first operator pose corresponding to the operator rolling on the floor; and deploy a first fire extinguisher, from the first set of materials at the autonomous cart, toward the operator proximal the first location.

### 12.5 Example: Electrical Emergency

In another example, the robotic loading system can access a loading schedule defining a first task performed by the operator within the facility that includes a risk level corresponding to an electrical exposure risk associated with performance of the first task.

In this example, the robotic loading system can: identify a set of electrical emergency materials (e.g., lockout/tagout supplies, robotic arm for emergency equipment shutoff, grounded equipment) corresponding to the electrical exposure risk level from a manifest of emergency materials; and trigger loading of the set of electrical emergency materials. The autonomous cart can then autonomously maneuver to a target location within the facility proximal the operator to deliver the set of electrical emergency materials to the operator for performance of the first task. Thus, the autonomous cart can automatically deploy the set of electrical emergency materials—which are not included in the baseline emergency materials—to operators performing electrical exposure tasks within the facility.

### 12.6 Example: Emergency Spill Cleanup

In another example, an autonomous spill cleanup cart can be deployed to assist in the cleanup of spills and biohazardous materials. With single-use bioreactors becoming more commonly used in the biopharmaceutical industry the opportunity for the bags to tear or be punctured resulting in a spill of biohazardous materials increases. This requires new strategies to deal with the cleanup of potentially biohazardous and infectious materials containing cells, bacteria, viruses, or other potentially infectious agents with large scale cleanups. In these cleanups it is essential to control the location and movement of fluids and to be sure that they are not producing dangerous aerosols that can potentially infect the operators tasked with cleaning up spills. The priorities are to contain the spills and confine it to a smaller area, then provide the proper personal protective equipment (PPE) to deal with the spill properly, depending on the specific hazards they are dealing with.

In this example an autonomous spill cleanup cart is dispatched when a spill is manually called or automatically detected by a sensor, such as a leak sensor or computer vision from a camera in the room where the frames of the spill growing are reported to the system which goes into alarm to dispatch the autonomous spill cleanup cart. From the standpoint of operator safety and to minimize the particulates, operators generally leave the area allow any aerosols from the spill to settle prior to working on the spill. If the facility is properly designed the fluid from the leak should sit in a depression in the floor designed to hold more than the volume of the largest tank in the room. This is not always the case and in those situations the operators need to move quickly to setup a barrier to prevent the fluid spill from entering into other areas, potentially disrupting other operations, preventing the fluid spill from entering into areas with sensitive electronics or systems that can be damaged or destroyed from the fluid spill, and/or the prevention of the fluid spill, particularly a nutrient rich fluid spill (such as cell culture media) from entering into areas of the facility that can be hard to clean or that can harbor bacteria, mold, and other biological contaminates which can be hard to completely remove from a facility. In addition to the autonomous spill cleanup cart an additional standard autonomous cart can deliver spill cleanup supplies to the operators such as rubberized boots, absorbent or non-absorbent barriers, squeegees, neutralizing chemicals (such as bleach for cell culture media containing live cells, bacteria, or viruses), and Personal Protective Equipment (PPE) such as Tyvek gowns, rubberized gloves, rubber barrier gowns, face shields, safety goggles, or breathing apparatuses like a Powered Air Purifying Respirator (PAPR) including different sizes for the different operators to select from.

The autonomous spill cleanup cart when it enters the area with the spill can be autonomously containing the spill if the other operators have left the area due to safety concerns of the material spilled. The autonomous spill cleanup cart can be remotely navigated from a remote operator viewing the positioning of the autonomous cart relative to the spill via at least one sensing device, preferably a camera device, and a network connection. Alternatively, the autonomous spill cleanup cart can operate on its own utilizing an AI software paired with the computer vision to locate the spill, determine the size and shape of the spill, determine the size and shape of the room as well as equipment that can be in the way, prioritize which location needs to be protected first and determine the optimal way to contain the spill. The autonomous spill cleanup cart contains at least one dispensing device for a barrier material such as an absorbent or non-absorbent barrier material. An absorbent barrier material can be made from an absorbent material like silica dioxide, clays, vermiculite, fabrics, sponges, or other materials. These absorbent materials can be dispensed as mats, sheets, socks, booms, pillows, bricks, or other types. The non-absorbent barriers can be made from chemically compatible plastic materials that serve as a barrier or dike to prevent fluid from getting through or to redirect the fluid into an alternate direction or flow path. The autonomous spill cleanup cart in response to a spill can deploy the absorbent or non-absorbent barrier using the spool for barrier dispenser. The spool can unwind a boom, sock, linked bricks, or other barrier to prevent fluid from passing the barrier location. The autonomous spill cleanup cart can deploy the absorbent or non-absorbent barrier at the perimeter of the spill to prevent it from going any further, interior to the spill to soak up the spill or to redirect it, or preemptively away from the spill as a preventative measure around key access points such as doorways, vulnerable points, or critical infrastructure.

Once the absorbent or non-absorbent barrier is deployed the autonomous spill cleanup cart can utilize a retractable squeegee assembly to push or move the fluid towards a floor drain, absorbent mats/pads, or other location where the spill cleanup can occur. The squeegee can be in the retracted state when the autonomous spill cleanup cart is driving normally to a location and the squeegee can be in the deployed state when it is actively pushing fluid from a spill to a particular location.

The autonomous spill cleanup cart will be able to handle hazardous spills which can be biohazardous, toxic, flammable, explosive, or dangerous to have operators interacting with the spill material until they have properly prepared with the correct personal protective equipment (PPE) and allowed sufficient time to pass for the removal of aerosols to be removed from the air. In cases where a spill is dangerous to operators the autonomous spill cleanup cart can utilize a chemical neutralizing agent to render the spill safer to the operators or for making the cleanup or disposal easier. This can include neutralizing any potential biohazardous spills containing cell culture products, bacteria, yeast/mold, viruses, parasites or other potential pathogens with bleach, detergents, or chemical agents that can inactivate the materials to make the spill safer to handle by operators. This can also include chemical spills where the spill materials are strongly acidic or basic and where the neutralizing agent brings the pH of the spill back to a neutral level where it can be more safely handled or disposed. In other events, the spill material can be toxic and needs to be inactivated using a chemical antagonist to impede the toxic pathway of the toxic material and to neutralize it to help render it safe or safer to handle for cleanup. The neutralizing spray material can be swapped out depending on the type of spill the autonomous spill cleanup cart is attempting to cleanup. The neutralizing spray can utilize a compressed gas to dispense the material through a directed nozzle over an area of the spill to provide the optimal contact with the spill material to neutralize it. The autonomous spill cleanup cart can be decontaminated after the spill cleanup has been completed.

### 12.7 Example: Emergency HEPA Filtration Cart

In another example, an autonomous HEPA filtration cart can be deployed to assist in filtering the air inside facilities where the filtration capacity is insufficient to protect the operators, product, equipment, or facilities. This is important during instances where the building HEPA filtration systems can fail in the middle of a batch run, if the power goes out and operators are potentially exposed to hazardous aerosolized particles like viruses, or if the air filtration system capacity is not sufficient to meet an air quality standard specification during processing. The autonomous HEPA filtration cart can be deployed on standby in a location within the facility prior to a critical event and be programmed to come online if the air quality, usually measured with a laser particle counter drops below a certain specification. This laser particle counter can be connected to or integrated with the autonomous HEPA filtration cart and when the air quality specification is not met the portable HEPA filtration system automatically turns on to provide assistance as a local filtration system to overcome the deficiencies of the broader facility HEPA filtration system or local conditions/events that could come up during parts of the process.

In alternate cases the autonomous HEPA filtration cart can be dispatched to a location in a facility after an event has occurred, such as a power outage or mechanical issue with the facility HEPA filtration system. The autonomous HEPA filtration cart can be dispatched manually by an operator using the system or can be dispatched automatically by the system in response to a sensor detecting a triggering event has occurred, such as a power outage or mechanical failure. The autonomous HEPA filtration cart can provide assistance in the short term to allow the operators to properly shut down a processing line and buy the time needed to secure the remaining product into sealed containers to protect it during the time period the facility HEPA filtration systems are down to prevent possible points of contamination or risk to needing to discard the product.

In still alternate cases the autonomous HEPA filtration cart can be deployed as a backup system for protecting operators when handling particularly dangerous pathogens or materials which could aerosolize and get past barrier system or Personal Protective Equipment the operator is wearing, such as in confined spaces working with controlled substances, hormones, viruses without any known treatment or cures, prions, CRISPR products which can alter the operator's genetic sequences, antibodies, or other treatment types which can affect the operator's working on them.

### 12.8 Example: Emergency Evacuation Signage

In another example, an emergency evacuation signage cart can be deployed to assist in the evacuation of a building by moving to key positions to provide information on egress points and areas of the facility not to go. In this example an autonomous cart can be specialized, have the signage equipment integrated into the autonomous cart body, and be held in a pre-positioned standby for usage during evacuation and evacuation drill events. In other instances, a standard autonomous cart can be prioritized to be loaded with a tray containing the signage equipment by the robotic loading system and then travel to the key points in the facility to direct personnel on which directions to evacuate and where are the building egress points. In this instance a standard autonomous cart with a signage equipment tray needs to ensure it is not blocking users as they are trying to evacuate a building by clogging up valuable space in a hallway or in doorways. In these instances, the standard autonomous cart can take routes with less foot traffic associated with them or with wider hallways, so they are not interfering with the flow of people during the evacuation process.

The emergency evacuation signage carts can provide lighted signs pointing the direction people should be evacuating to. These can include directional arrows, large and clear text instructions, and/or audio instructions out of a speaker device. These emergency evacuation signage carts can deploy at critical areas along the pathway for users to tell them where they need to go next. The emergency evacuation signage carts can be controlled remotely by a human operator to determine where they should be positioned in the facility based on the current information on where the source of the evacuation is coming from. In alternate instances the emergency evacuation signage carts are automatically deployed to particular locations (e.g., obstruct locations within the facility) with specific instructions on the directionality and evacuation instructions to provide. In more advances instances the emergency evacuation signage carts position themselves in key locations throughout the facility but can provide updated instructions on what information to provide at each location in case areas of the facility the instructions would normally tell people to go are the cause for the evacuation and are not be accessible. In these instances, the emergency evacuation signage carts can receive updated information to inform people evacuating from the building not to enter into an area or go into certain areas of the facility. This can be the case for fire, flooding, explosion, or an active shooter where real time information and instructions are critical for the safety of the people trying to evacuate. The emergency evacuation signage carts and the standard autonomous cart with a signage equipment tray can additionally contain first aid kits, water, flashlights, respirators/masks, radios, a tablet with a manifest of all employees and guests currently in a facility at that time and other items to assist in the safety and health of the people evacuating from the building.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for autonomously delivering supplies to operators performing procedures within a facility comprising, at a first autonomous cart:
accessing a digital procedure containing a first instructional block, in a sequence of instructional blocks, the first instructional block comprising a first instruction defining:
a first location within the facility;
a first supply trigger associated with a first set of materials for an operator scheduled to perform the digital procedure at the first location; and
a first target offset distance between the first autonomous cart and the operator proximal the first location;
at a first time prior to scheduled performance of the first instruction by the operator, maneuvering the first autonomous cart to a target position within the facility proximal the first location defined in the first instruction of the first instructional block, the first autonomous cart containing the first set of materials;
in response to detecting the first supply trigger proximal the first location, initializing a first scan cycle, during the first scan cycle:
accessing a first live video feed from a first optical sensor coupled to the first autonomous cart and defining a first line-of-sight of the first autonomous cart;
extracting a first set of visual features from the first live video feed;
interpreting a first set of objects depicted in the first live video feed based on the first set of visual features, the first set of objects comprising a first object corresponding to the operator within the first line-of-sight; and
calculating a first offset distance between the first object depicted in the first live video feed and the first autonomous cart;
in response to the first offset distance between the first object and the first autonomous cart deviating from the first target offset distance, maneuvering the first autonomous cart to the first target offset distance; and
in response to completion of the first instruction by the operator, maneuvering the first autonomous cart to a second location within the facility associated with a second instructional block, in the sequence of instructional blocks, of the digital procedure.

2. The method of claim 1:
wherein accessing the digital procedure containing the first instructional block, in the sequence of instructional blocks, comprises extracting an operator profile from the digital procedure associated with the operator performing the first instructional block, the digital procedure defining:
a first degree of guidance for performing the first instruction; and
a first target signal strength associated with the first degree of guidance for the first instruction and a first mobile device associated with the operator;
further comprising, during a second scan cycle:
reading a first set of wireless network signals, received from the first mobile device associated with the operator, from a network device coupled to the first autonomous cart;
interpreting a first signal strength between the first mobile device and the network device at the first autonomous cart based on the first set of wireless network signals; and
calculating a second target offset distance between the mobile device and the first autonomous cart to achieve the first target signal strength based on the first set of wireless network signals, the first target signal strength, and the first target offset distance; and
further comprising, in response to the first signal strength deviating from the target signal strength, maneuvering the first autonomous cart to the second target offset distance from the operator.

3. The method of claim 1:
wherein calculating the first offset distance between the first object depicted in the first live video feed and the first autonomous cart comprises calculating a first radial offset distance, at a first positional resolution, about the first autonomous cart based on the first set of objects depicted in the first live video feed;
further comprising, in response to the first positional resolution of the first radial offset distance falling below a positional resolution threshold:
reading a first set of wireless network signals, received from a first mobile device associated with the operator, from a network device coupled to the first autonomous cart;
interpreting a first signal strength between the first mobile device and the network device at the first autonomous cart based on the first set of wireless network signals; and
calculating a second radial offset distance between the operator and the first autonomous cart, at a second positional resolution greater than the first positional resolution, based on the first signal strength and the first set of objects depicted in the first live video feed; and
wherein maneuvering the first autonomous cart to the first target offset distance comprises, in response to the second offset distance at the second positional resolution deviating from the first target offset distance, maneuvering the first autonomous cart to the first target offset distance.

4. The method of claim 1, further comprising:
in response to initiating the first instructional block by the operator proximal the first location at the facility:
maneuvering the first autonomous cart to a second offset distance, less than the first offset distance, between the operator proximal the first location and the first autonomous cart; and
detecting removal of the first set of materials at the first autonomous cart by the operator proximal the first location;
at a second time period following the first time, in response to detecting removal of the first set of materials from the first autonomous cart, maintaining the first target offset distance between the operator and the first autonomous cart during performance of the first instruction; and
at a third time following the second time period and in response to completion of the first instructional block by the operator:
maneuvering the first autonomous cart to the second offset distance between the operator and the first autonomous cart;
detecting loading of a second material, at the first autonomous cart by the operator, associated with completion of the first instruction in the first instructional block; and
in response to detecting loading of the second material at the first autonomous cart, maneuvering the first autonomous cart to the second location within the facility associated with the second instructional block, in the sequence of instructional blocks, and the second material.

5. The method of claim 1, wherein detecting the first supply trigger proximal the first location comprises:
at a mobile device associated with the operator, receiving selection of a first degree of guidance in a first format for the first instruction of the first instructional block; and
in response to identifying a first material, in the first set of materials at the first autonomous cart, associated with the first degree of guidance for the first instruction, detecting the first supply trigger proximal the first location.

6. The method of claim 1, wherein detecting the first supply trigger proximal the first location comprises:
accessing a second live video feed from the optical sensor defining the first line of sight of the first autonomous cart;
extracting a second set of visual features from the second live video feed;
interpreting an operator pose for the operator proximal the first location based on the second set of visual features; and
in response to the operator pose corresponding to a first gesture, in a set of gestures, assigned to the first supply trigger, detecting the first supply trigger proximal the first location within the facility.

7. The method of claim 1:
further comprising, at a remote computer system:
accessing the digital procedure containing a second instructional block, in the sequence of instructional blocks, the second instructional block defining a second location within the facility associated with performance of the second instruction by the operator;
accessing an object manifest representing objects related to performance of the second instructional block by the operator;
identifying a second set of materials in the object manifest related to the second instructional block based on the second instruction; and
querying an autonomous cart list to identify a second autonomous cart containing the second set of materials; and
further comprising, at the second autonomous cart:
at a second time prior to completion of the first instructional block by the operator, maneuvering the second autonomous cart to a second position within the facility proximal the second location; and
maintaining a second target offset distance, greater than the first target offset distance, from the operator during performance of the first instructional block.

8. The method of claim 1:
wherein accessing the digital procedure comprises, accessing the digital procedure containing a first instructional block, in the sequence of instructional blocks, the first instructional block comprising an object manifest corresponding to a list of objects related to performance of the first instructional block in the digital procedure; and
further comprising:
during the first scan cycle:
extracting a first subset of objects, from the first set of objects, related to performance of the first instruction based on the object manifest for the digital procedure; and
identifying absence of a second object in the object manifest absent from the first subset of objects;
in response to identifying absence of the second object in the first subset of objects, generating a prompt to deliver the second object to the operator proximal the first location within the facility;
serving the prompt to a remote computer system;
at the remote computer system, querying an autonomous cart manifest for a second autonomous cart containing the second object; and
at the second autonomous cart, maneuvering to the target position proximal the first location to locate the second object proximal the operator at the target location.

9. The method of claim 1, further comprising, at a remote computer system:
accessing the digital procedure containing the first instructional block, in the sequence of instructional blocks, the first instructional block comprising a first instruction defining a first risk level associated with performance of the first instruction;
accessing an object manifest representing objects related to performance of the digital procedure;
identifying a second set of emergency materials in the object manifest based on the risk level associated with performance of the first instruction;
assigning a delivery location to the second set of emergency materials based on the first location for the digital procedure within the facility;
assigning the second supply trigger for the first set of emergency materials according to a first set of distress poses associated with the first risk level of the first instruction;
generating a loading prompt for a second autonomous cart comprising the second set of emergency materials, the delivery location, and the supply trigger; and
serving the loading prompt to a robotic loading system arranged at a first loading area within the facility.

10. The method of claim 9, further comprising:
at a first time prior to scheduled performance of the first instructional block by the operator at the first location, maneuvering the second autonomous cart to the first loading area within the facility to receive loading of the first set of emergency materials at the first autonomous cart;
in response to initiating the first instruction by the operator at the first location, maneuvering the second autonomous cart to the first location proximal the operator performing the first instruction; and
maintaining the first target offset distance between the second autonomous cart and the operator proximal the first location during performance of the first instruction.

11. The method of claim 10, further comprising, at the second autonomous cart:
accessing a second live video feed from a second optical sensor at the second autonomous cart defining a second line of sight of the operator performing the first instruction;
extracting a second set of visual features from the second live video feed;
interpreting an operator pose for the operator within the second line of sight of the second autonomous cart based on the second set of visual features; and
in response to identifying the operator pose for the operator as corresponding to a distress pose:
maneuvering the second autonomous cart to a second target offset distance less than the first target offset distance between the operator and the first autonomous cart; and
deploying the second set of emergency materials at the second autonomous cart toward the operator.

12. The method of claim 1, wherein maneuvering the first autonomous cart to the first position within the facility comprises:
accessing a facility map representing a set of locations within the facility;
accessing a procedure schedule representing procedures scheduled for performance at target locations within the facility over a first duration of time;
generating a first set of labels specifying target locations for performing instances of procedures based on the procedure schedule;
assigning the first set of labels to a subset of locations, in the set of locations, in the facility map, the subset of locations comprising the first location;
calculating a first path from a first autonomous cart station within the facility, containing the first autonomous cart, to the first position proximal the first location based on the facility map to avoid the subset of locations;
serving the first path to the first autonomous cart; and
at the first time, maneuvering the first autonomous cart to the first position within the facility proximal the first location according to the first path.

13. A method for autonomously delivering supplies to operators performing procedures within a facility comprising:
accessing a digital procedure containing a first instructional block, in a sequence of instructional blocks, the first instructional block comprising a first instruction defining:
a first location within the facility;
a first risk level associated with performance of the first instruction; and
a first supply trigger associated with a first set of materials according to the first risk level for the first instruction; and
at a first autonomous cart containing the first set of materials:
maneuvering to a target position proximal the first location within the facility;
in response to the operator initiating the first instruction in the digital procedure, maintaining a first target offset distance between the first autonomous cart and the operator proximal the first location;
accessing a first live video feed from a first optical sensor at the first autonomous cart defining a first line of sight of the operator performing the first instruction;
extracting a first set of visual features from the first live video feed;
interpreting an operator pose for the operator within the line of sight of the first autonomous cart based on the first set of visual features; and
in response to identifying the operator pose for the operator as corresponding to a distress pose:
maneuvering the first autonomous cart to a second target offset distance less than the first target offset distance between the operator and the first autonomous cart; and
deploying the first set of materials at the first autonomous cart toward the operator.

14. The method of claim 13, wherein maintaining the first target offset distance between the first autonomous cart and the operator comprises, during a first scan cycle at the first autonomous cart:
accessing a second live video feed from the first optical sensor at the first autonomous cart and defining a first line-of-sight of the first autonomous cart;
extracting a second set of visual features from the second live video feed;
interpreting a second set of objects depicted in the second live video feed based on the second set of visual features, the second set of objects comprising a second object corresponding to the operator within the first line-of-sight;
calculating an offset distance between the second object depicted in the second live video feed and the first autonomous cart; and
in response to the offset distance between the second object and the first autonomous cart deviating from the first target offset distance, maneuvering the first autonomous cart to the first target offset distance.

15. The method of claim 13, further comprising:
extracting a second set of visual features from a second video segment in the first live video feed depicting the operator;
interpreting a first set of objects within the first line of sight of the first autonomous cart based on the second set of visual features;
identifying a first object, in the first set of objects, as corresponding to the operator proximal the first location in the facility;
identifying a second subset of objects, in the first set of objects, within the line of sight of the first autonomous cart and obstructing view of the first object in the first live video feed;
calculating a second position proximal the first location in the facility based on the first object and the second subset of objects; and
maneuvering the first autonomous cart to the second position, at the target offset distance, proximal the first location within the facility.

16. The method of claim 13:
further comprising:
reading a timeseries of temperature values from a temperature sensor arranged proximal the operator at the first location; and
identifying a subset of temperature values, in the timeseries of temperature values, exceeding a threshold temperature value corresponding to the first risk level for the first instruction;
wherein interpreting the operator pose comprises:
extracting a first set of distress poses associated with the first risk level for the first instruction, the first risk level corresponding to a flammable risk level; and
identifying the operator pose as corresponding to a first operator pose, in the set of distress poses, associated with the operator rolling on the floor proximal the first location;
further comprising identifying an emergency fire event at the first location within the facility based on the first subset of temperature values and the first operator pose corresponding to the operator rolling on the floor; and
wherein deploying the first set of materials at the first autonomous cart comprises, in response to identifying the emergency fire event, deploying a first fire extinguisher, from the first set of materials at the first autonomous cart, toward the operator proximal the first location.

17. The method of claim 13:
wherein interpreting the operator pose comprises, interpreting the operator pose at a first pose resolution for the operator within the line of sight of the first autonomous cart based on the first set of visual features from the first live video feed;
further comprising, in response to the first pose resolution falling below a threshold pose resolution:
accessing a second live video feed from a second optical sensor arranged proximal the first location within the facility and defining a second line of sight, different from the first line of sight, of the operator performing the first instruction;
extracting a second set of visual features from the second live video feed;
accessing a third live video feed from a third optical sensor arranged at a headset device associated with the operator and defining a third line of sight, different from the first line of sight and the second line of sight, of the operator performing the first instruction;
extracting a third set of visual features from the third live video feed; and
interpreting the operator pose for the operator proximal the first location, at a second pose resolution greater than the first pose resolution, based on the first set of visual features, the second set of visual features, and the third set of visual features; and
wherein identifying the operator pose as corresponding to the distress pose comprises, identifying the operator pose, at the second pose resolution, as corresponding to the distress pose.

18. The method of claim 13, further comprising, at a remote computer system:
accessing an object manifest representing objects related to performance of the digital procedure;
identifying a first set of emergency materials in the object manifest based on the risk level associated with performance of the first instruction;
assigning a delivery location to the first set of emergency materials based on the first location for the digital procedure within the facility;
assigning the supply trigger for the first set of emergency materials based on a first set of distress poses associated with the first risk level of the first instruction;
generating a loading prompt for the first autonomous cart comprising the first set of emergency materials, the delivery location, and the supply trigger;
serving the loading prompt to a robotic loading system arranged at a first loading area within the facility; and
at a first time prior to scheduled performance of the first instructional block by the operator at the first location, maneuvering the first autonomous cart to the first loading area within the facility to receive loading of the first set of emergency materials at the first autonomous cart.

19. A method for autonomously delivering supplies to operators performing procedures within a facility comprising:
accessing a digital procedure containing a first instructional block, in a sequence of instructional blocks, the first instructional block comprising a first instruction defining:
a first location within the facility; and
a first target offset distance between the first autonomous cart and the operator proximal the first location;
at an autonomous cart containing a first set of materials associated with performance of the first instruction, maneuvering to a target position within the facility proximal the first location defined in the first instruction of the first instructional block;
in response to initiating the first instruction by the operator, accessing a first live video feed from a first optical sensor coupled to the first autonomous cart and defining a first line-of-sight of the first autonomous cart;
extracting a first set of visual features from the first live video feed;
interpreting a first set of objects depicted in the first live video feed based on the first set of visual features, the first set of objects comprising a first object corresponding to the operator within the first line-of-sight;
calculating a first offset distance between the first object depicted in the first live video feed and the first autonomous cart based on the first set of objects and the target position of the first autonomous cart within the facility; and
in response to the first offset distance between the first object and the first autonomous cart deviating from the first target offset distance, maneuvering the first autonomous cart to the first target offset distance.

20. The method of claim 19:
wherein accessing the digital procedure comprises, accessing the digital procedure containing the first instructional block, in the sequence of instructional blocks, the first instructional block comprising the first instruction defining a first target signal strength for a first mobile device associated with the operator; and
further comprising:
reading a first set of wireless network signals, received from the first mobile device associated with the operator, from a network device coupled to the first autonomous cart;
interpreting a first signal strength for the first mobile device at the network device based on the first set of wireless network signals;
in response to the first signal strength deviating from the first target signal strength, modifying the first target offset distance to a second target offset distance less than the first target offset distance; and
maneuvering the first autonomous cart to the second target offset distance proximal the operator at the first location.
